(19) United States
(12) Patent Application Publication
(10) Pub. No.: US 2024/0314236 A1
(43) Pub. Date: Sep. 19, 2024

(54) ELECTRONIC DEVICE, AND METHOD BY WHICH ELECTRONIC DEVICE DISPLAYS DISPLAY MODE INFORMATION ON BASIS OF CONTEXT INFORMATION

(71) Applicant: SAMSUNG ELECTRONICS CO., LTD., Suwon-si (KR)

(72) Inventors: Jaemyoung LEE, Suwon-si (KR); Nayoon LEE, Suwon-si (KR); Sooryuh KIM, Suwon-si (KR); Joonhwan KIM, Suwon-si (KR); Seungwook NAM, Suwon-si (KR); Soryang BAN, Suwon-si (KR); Chansu AHN, Suwon-si (KR); Seoyoung YOON, Suwon-si (KR); Minkyung LEE, Suwon-si (KR); Younghak OH, Suwon-si (KR)

(21) Appl. No.: 18/673,473

(22) Filed: May 24, 2024

Related U.S. Application Data
(63) Continuation of application No. PCT/KR2022/016004, filed on Oct. 20, 2022.

(30) Foreign Application Priority Data
Nov. 26, 2021 (KR) 10-2021-0165192
Jan. 17, 2022 (KR) 10-2022-0006472

(51) Int. Cl. H04M 1/72448; H04M 1/02

(52) U.S. Cl. CPC H04M 1/72448; H04M 1/0235; H04M 1/0268

(57) ABSTRACT

An electronic device includes: a flexible display connected to a housing; a slide driving unit for sliding the flexible display in the extension/reduction direction; and a processor operably connected to the flexible display and slide driving unit, wherein the processor is configured to identify, responsive to execution of an application, a display event for a display mode option while displaying a screen of the application on the flexible display, identify, responsive to the display event for the display mode option, first context information based on context information associated with the electronic device, display, responsive to the first context information, a first display mode option including view modes associated with the application or electronic device, identify second context information responsive to a change in context information associated with the electronic device, and display a second display mode apart from the first display mode option responsive to the second context information.

### CROSS-REFERENCE TO RELATED APPLICATION(S)

This application is a continuation of International Application No. PCT/KR2022/016004, filed on Oct. 20, 2022, which claims priority to Korean Patent Application No. 10-2022-0006472, filed on Jan. 17, 2022 and Korean Patent Application No. 10-2021-0165192, filed on Nov. 26, 2021, in the Korean Intellectual Property Office, the disclosures of which are herein incorporated by reference.

### TECHNICAL FIELD

Various embodiments of the disclosure relate to a display method of an electronic device.

### BACKGROUND ART

In line with the development of electronic, information, and communication technologies, various functions are being integrated into a single portable communication device or electronic device. For example, smartphones include functions of an audio reproduction device, an imaging device, or an electronic notebook, as well as communication functions, and a wider variety of functions may be implemented in the smartphones by installing additional applications.

As personal or portable communication devices such as smartphones are widely used, user demands for portability and ease of use are increasing. For example, a touch screen display is an output device that outputs a screen, for example, visual information, and may provide a virtual keypad replacing a mechanical input device (for example, a button-type input device). As a result, portable communication devices or electronic devices may provide the same or improved usability (e.g., a larger screen) while being miniaturized. On the other hand, as flexible displays, for example, foldable or rollable displays, are commercialized, the portability and convenience of use of electronic devices are expected to further improve.

### DETAILED DESCRIPTION OF THE INVENTION

### Technical Problem

The display screen of current electronic devices equipped with flexible displays may be changed into various sizes by physically expanding or reducing the flexible displays. For example, an electronic device may display a content screen (e.g., an application screen (execution screen)) on the reduced display screen in the state in which the flexible display is reduced, and then display an application screen on the expanded display screen when the flexible display is expanded.

Although the display screen of the electronic device is adjustable and various types of application screens may be displayed on the display, it may be difficult for a user to select a specific view mode from among various view modes in various situations. For example, in existing electronic devices, it may be difficult for the user to select various display modes (e.g., view modes) depending on the status (e.g., locations or time) of the electronic device (or user) or the display content (or layout) of the current application.

According to various embodiments of the disclosure, there is provided an electronic device that allows a user to select one of various display modes, based on context information according to the status of the electronic device or the display content of the current application, and a method of providing context-based display mode information in the electronic device.

According to various embodiments of the disclosure, there is provided an electronic device that provides first display mode information in first context information and provides second display mode information in second context information depending on the status of the electronic device or the display content of the current application, enabling the user to select an appropriate display mode depending on the status of the electronic device or the display content of the current application, and a method of providing context-based display mode information in the electronic device.

### Technical Solution

According to an embodiment of the disclosure, an electronic device may include a housing, a flexible display connected to the housing, a slide driving unit configured to slide the flexible display in an extension direction or reduction direction, and at least one processor operably connected to the flexible display and the slide driving unit. The at least one processor may be configured to identify, based on execution of an application, a display event for a display mode option while displaying a screen of the application on the flexible display, identify first context information, based on context information associated with the electronic device, according to the display event for the display mode option, and display a first display mode option including at least some or all of the view modes associated with the application or the electronic device, based on the first context information. The at least one processor may be configured to identify second context information, based on a change in the context information associated with the electronic device, and display a second display mode option different from the first display mode option, based on the second context information.

According to an embodiment of the disclosure, a method of displaying display mode information, based on context information, in an electronic device may include, based on execution of an application, identifying a display event for a display mode option while displaying a screen of the application on a flexible display, identifying first context information based on context information associated with the electronic device, according to the display event for the display mode option, displaying a first display mode option including at least some or all of the view modes associated with the application or the electronic device, based on the first context information, identifying second context information, based on a change in the context information associated with the electronic device, and displaying a second display mode option different from the first display mode option, based on the second context information.

According to an embodiment of the disclosure, there is provided a non-volatile storage medium storing instructions configured to cause, when executed by at least one processor, the at least one processor to perform at least one operation, wherein the at least one operation may include, based on execution of an application, identifying a display event for a display mode option while displaying a screen of the application on a flexible display, identifying first context information based on context information associated with the electronic device, according to the display event for the display mode option, displaying a first display mode option including at least some or all of the view modes associated with the application or the electronic device, based on the first context information, identifying second context information, based on a change in the context information associated with the electronic device, and displaying a second display mode option different from the first display mode option, based on the second context information.

### Advantageous Effects

According to various embodiments of the disclosure, an electronic device may enable a user to select one of various display mode options, based on context information according to the status of the electronic device or the display content of the current application.

According to various embodiments of the disclosure, a first display mode option may be provided in first context information, and a second display mode option may be provided in second context information depending on the status of the electronic device or the display content of the current application, enabling the user to select an appropriate display mode depending on the status of the electronic device or the display content of the current application.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1 is a block diagram of an electronic device in a network environment according to one embodiment.

FIG. 2A is a diagram illustrating the state in which a second display area of a flexible display is received inside a second housing according to an embodiment.

FIG. 2B is a diagram illustrating the state in which a second display area of a flexible display is exposed to the outside of a second housing according to an embodiment.

FIG. 3 is a block diagram of an electronic device according to an embodiment.

FIG. 4 is a flowchart illustrating an operation of displaying a display mode option in an electronic device according to an embodiment.

FIG. 5 is a diagram illustrating an example of displaying a display mode option in an electronic device according to an embodiment.

FIG. 6 is a diagram illustrating an example of displaying a display mode option when displaying a video playback application screen in an electronic device according to an embodiment.

FIG. 7 is a diagram illustrating an example of display mode option when displaying a gallery application screen in an electronic device according to an embodiment.

FIG. 8A is a diagram illustrating an example of displaying a display mode option when displaying an email application screen in an electronic device according to an embodiment.

FIG. 8B is a diagram illustrating an example of displaying display mode information while displaying an email application screen according to an email drawer view mode in an electronic device according to an embodiment.

FIG. 9 is a diagram illustrating an example of displaying a display mode option when displaying a note application screen in an electronic device according to an embodiment.

FIG. 10A is a diagram illustrating an example of displaying a display mode option when displaying a calendar application screen in an electronic device according to an embodiment.

FIG. 10B is a diagram illustrating an example of displaying a calendar application screen according to a month view mode in an electronic device according to an embodiment.

FIG. 11 is a diagram illustrating an example of displaying a display mode option according to an embodiment.

FIG. 12 is a diagram illustrating an example of displaying an application screen based on selection of a display size if a display mode option includes a display screen size indicator according to an embodiment.

FIG. 13 is a diagram illustrating an example of displaying a display mode option associated with multiple application screens according to an embodiment.

FIG. 14A is a diagram illustrating an example of displaying a display mode option including a home view mode button, a pop-up view mode button, and a split view mode button when displaying multiple application screens in an electronic device according to an embodiment.

FIG. 14B is a diagram illustrating an example of a split view mode according to an embodiment.

FIG. 15 is a diagram illustrating an example of displaying a display mode option including a normal view mode, a horizontal view mode, and a vertical view mode when displaying multiple application screens in an electronic device according to an embodiment.

FIG. 16 is a diagram illustrating an example of displaying a display mode option if an application does not include a specified view mode in an electronic device according to an embodiment.

FIG. 17 is a diagram illustrating an example of displaying a display mode option based on usage history for an application in an electronic device according to an embodiment.

With regard to the description of the drawings, similar or like reference numerals may be used to designate similar or like elements.

### MODE FOR CARRYING OUT THE INVENTION

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

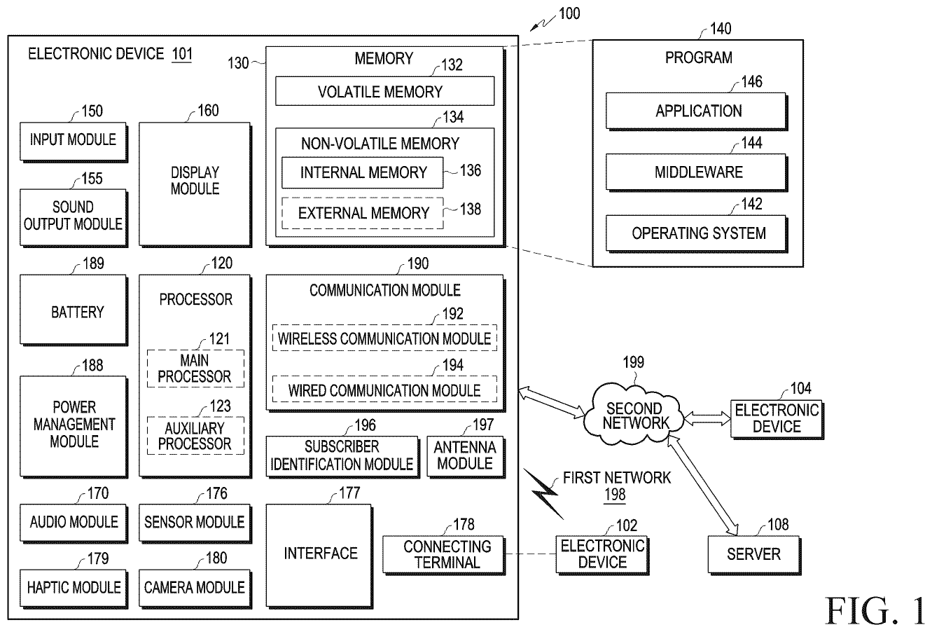

FIG. 1 is a block diagram illustrating an electronic device 101 in a network environment 100 according to embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing 1 eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example.

The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

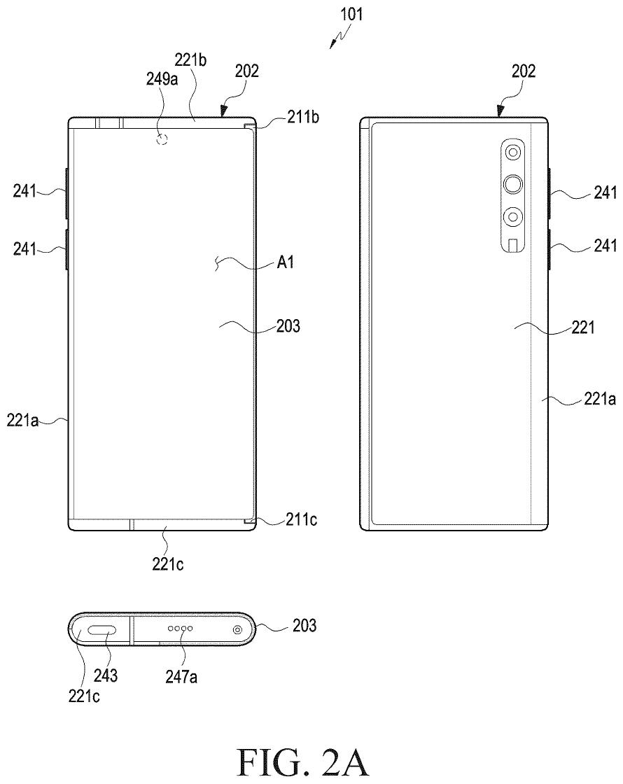

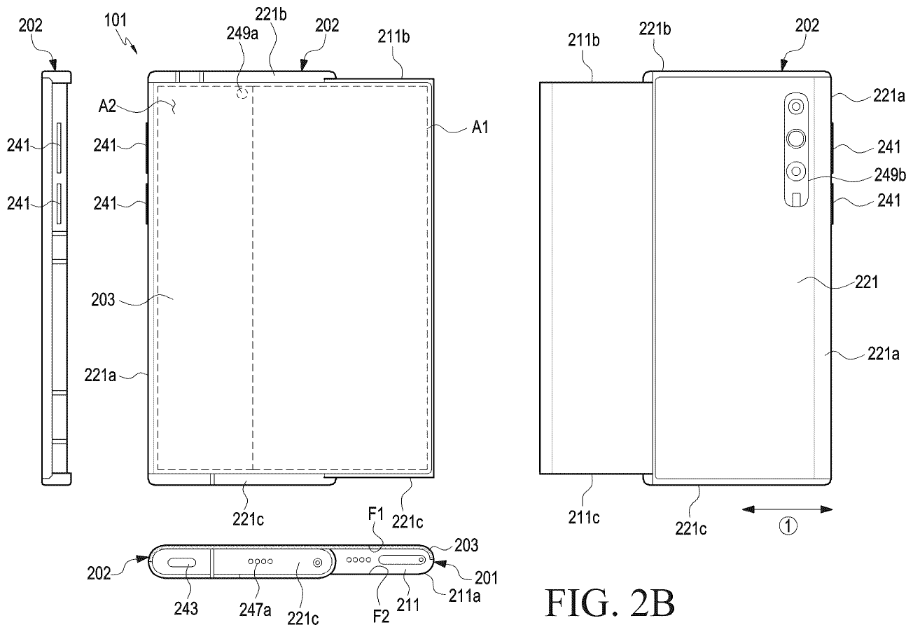

FIG. 2A is a diagram illustrating the state in which a second display area of a flexible display is received inside a second housing according to an embodiment. FIG. 2B is a diagram illustrating the state in which a second display area of a flexible display is exposed to the outside of a second housing according to an embodiment.

FIGS. 2A and 2B show a structure in which the electronic device 101 expands to the right of the flexible display 203 when viewed from the front thereof. The state shown in FIG. 2A may be defined as a closed state of a first housing 201 in FIG. 2B relative to a second housing 202, and the state shown in FIG. 2B may be defined as an open state of the first housing 201 relative to the second housing 202. Depending on the embodiment, the “closed state” or “open state” may be defined as the state in which the electronic device is closed or open.

Referring to FIGS. 2A and 2B, the electronic device 101 may include housings 201 and 202. The housings 201 and 202 may include a second housing 202 and a first housing 201 disposed to be movable relative to the second housing 202. In a certain embodiment, it may be construed that the second housing 202 is disposed to slide on the first housing 201 in the electronic device 101. According to an embodiment, the first housing 201 may be disposed to reciprocate a certain distance in the illustrated direction, for example, the direction indicated by the arrow \textcircled{1}, relative to the second housing 202. The configurations of the electronic device 101 in FIGS. 2A and 2B may be the same as all or some of the configurations of the electronic device 101 in FIG. 1.

According to an embodiment, the first housing 201 may be called, for example, a first structure, a slide part, or a slide housing, and may be disposed to reciprocate on the second housing 202. According to an embodiment, the first housing 201 may accommodate various electrical and electronic components such as a circuit board or battery. The second housing 202 may be called, for example, a second structure, a main part, or a main housing, and may guide the movement of the first housing 201. A portion (e.g., a first display area A1) of a display 203 may be seated on the first housing 201. According to an embodiment, another portion (e.g., a second display area A2) of the display 203 may be received inside the second housing 202 (e.g., a slide-in operation) or exposed to the outside of the second housing 202 (e.g., a slide-out operation) as the first housing 201 moves (e.g., slides) relative to the second housing 202. According to an embodiment, a motor, a speaker, a SIM socket, and/or a sub-circuit board electrically connected to a main circuit board may be disposed in the first housing 201. A main circuit board having electrical components such as an application processor (AP) and a communication processor (CP) mounted thereon may be disposed in the second housing 202.

According to an embodiment, the first housing 201 may include a first plate 211 (e.g., a slide plate). The first plate 211 may include a first face (e.g., the first face F1 in FIG. 2B) forming at least a portion of the first plate 211 and a second face F2 facing in the opposite direction of the first face F1. According to an embodiment, the first plate 211 may support at least a portion (e.g., the first display area A1) of the display 203. According to an embodiment, the first housing 201 may include a first plate 211, a 1-1st side wall 211a extending from the first plate 211, a 1-2nd side wall 211b extending from the 1-1st side wall 211a and the first plate 211, and a 1-3rd side wall 211c extending from the 1-1st side wall 211a and the first plate 211 and parallel to the 1-2nd side wall 211b.

According to an embodiment, the second housing 202 may include a second plate (main case) 221, a 2-1st side wall 221a extending from the second plate 221, a 2-2nd side wall 221b extending from the 2-1st side wall 221a and the second plate 221, and a 2-3rd side wall 221c extending from the 2-1st side wall 221a and the second plate 221 and parallel to the 2-2nd side wall 221b. According to an embodiment, the 2-2nd side wall 221b and the 2-3rd side wall 221c may be formed perpendicular to the 2-1st side wall 221a. According to an embodiment, the second plate 221, the 2-1st side wall 221a, the 2-2nd side wall 221b, and the 2-3rd side wall 221c may be formed such that one side (e.g., a front face) thereof is open to accommodate (or surround) at least a portion of the first housing 201. For example, the first housing 201 may be coupled to the second housing 202 while being at least partially surrounded by the same, and may slide in a direction parallel to the first face F1 and the second face F2, for example, in the direction of arrow \textcircled{1}, while being guided by the second housing 202. According to an embodiment, the second plate 221, the 2-1st side wall 221a, the 2-2nd side wall 221b, and/or the 2-3rd side wall 221c may be formed as one piece. According to another embodiment, the second plate 221, the 2-1st side wall 221a, the 2-2nd side wall 221b, and/or the 2-3rd side wall 221c may be formed into separate housings and then combined or assembled.

According to an embodiment, the second plate 221 and/or the 2-1st side wall 221a may cover at least a portion of the flexible display 203. For example, at least a portion of the flexible display 203 may be received inside the second housing 202, and the second plate 221 and/or the 2-1st side wall 221a may cover a portion of the flexible display 203 received inside the second housing 202.

According to various embodiments, the first housing 201 may be movable between the open state and the closed state relative to the second housing 202 in a first direction (e.g., the direction \textcircled{1}) parallel to the 2-2nd side wall 221b or the 2-3rd side wall 221c, and the first housing 201 may be positioned at a first distance from the 2-1st side wall 221a in the closed state and at a second distance, which is greater than the first distance, from the 2-1st side wall 221a in the open state. In a certain embodiment, the first housing 201 may surround a portion of the 2-1st side wall 221a in the closed state.

According to an embodiment, the electronic device 101 may include a display 203, a key input device 241, a connector hole 243, audio modules 247a and 247b, or camera modules 249a and 249b. Although not shown, the electronic device 101 may further include an indicator (e.g., an LED device) or various sensor modules. The configurations of the display 203, audio modules 247a and 247b, and camera modules 249a and 249b in FIGS. 2A and 2B may be the same as all or some of the configurations of the display module 160, audio module 170, and camera module 180 in FIG. 1.

According to various embodiments, the display 203 may include a first display area A1 and a second display area A2. According to an embodiment, the first display area A1 may be disposed on the first housing 201. For example, the first display area A1 may be disposed on the first face F1 so as to extend across substantially at least a portion of the first face F1. The second display area A2 may extend from the first display area A1 and may be inserted or received into the second housing 202 (e.g., a structure) or exposed to the outside of the second housing 202 according to the slide movement of the first housing 201.

According to various embodiments, the second display area A2 may move substantially while being guided by one area of the first housing 201 so as to be received inside the second housing 202 or the space formed between the first housing 201 and the second housing 202 or exposed to the outside. According to an embodiment, the second display area A2 may move based on the slide movement of the first housing 201 in the first direction (e.g., the direction indicated by arrow \textcircled{1}). For example, while the first housing 201 slides, a portion of the second display area A2 may be deformed into a curved shape at a position corresponding to the curved surface of the first housing 201.

According to various embodiments, when viewed from the top of the first plate 211 (e.g., a slide plate), if the first housing 201 moves from the closed state to the open state, the second display area A2 may be gradually exposed to the outside of the second housing 202 to form a substantially flat surface together with the first display area A1. The display 203 may be combined with or disposed adjacent to a touch detection circuit, a pressure sensor capable of measuring the strength (pressure) of touch, and/or a digitizer that detects a magnetic field-type stylus pen. In an embodiment, the second display area A2 may be at least partially received inside the second housing 202, and a portion of the second display area A2 may be visually exposed to the outside even in the state shown in FIG. 2A (e.g., the closed state). According to an embodiment, regardless of the closed or open state, the exposed portion of the second display area A2 may be positioned on a portion of the first housing, and a portion of the second display area A2 may remain in the curved state.

According to an embodiment, the electronic device 101 may include at least one hinge structure (not shown). The hinge structure may connect the first housing 201 and the second housing 202. For example, the hinge structure may be connected to the first plate 211 and the second plate 221. According to an embodiment, the hinge structure may transmit a driving force for guiding the slide movement of the first housing 201 to the first housing 201. For example, the hinge structure may include an elastic material (e.g., a spring) and provides an elastic force in the first direction (e.g., the direction \textcircled{1} in FIG. 2B), based on the slide movement of the first housing 201. According to an embodiment, the hinge structure may be excluded.

According to an embodiment, the key input device 241 may be positioned in one area of the first housing 201. Depending on the appearance and state of use, the electronic device 101 may be designed to exclude the illustrated key input device 241 or to include additional key input devices. According to an embodiment, the electronic device 101 may include a key input device (not shown), for example, a home key button or a touch pad disposed around the home key button. According to another embodiment, at least a portion of the key input device 241 may be disposed on the 2-1st side wall 221a, the 2-2nd side wall 221b, or the 2-3rd side wall 221c of the second housing 202.

According to various embodiments, the connector hole 243 may be omitted depending on the embodiment, and may accommodate a connector (e.g., a USB connector) for transmitting and receiving power and/or data to and from an external electronic device. Although not shown, the electronic device 101 may include a plurality of connector holes 243, and some of the plurality of connector holes 243 may function as connector holes for transmitting and receiving audio signals to and from an external electronic device. In the illustrated embodiment, although the connector hole 243 may be disposed on the 2-3rd side wall 221c, the disclosure is not limited thereto, and the connector hole 243 or a connector hole (not shown) may be disposed on the 2-1st side wall 221a or the 2-2nd side wall 221b.

According to various embodiments, the audio modules 247a and 247b may include at least one speaker hole 247a or at least one microphone hole 247b. One of the speaker holes 247a may be provided as a receiver hall for voice calls, and the other may be provided as an external speaker hall. The electronic device 101 may include a microphone for obtaining sound, and the microphone may obtain external sound of the electronic device 101 through the microphone hole 247b. According to an embodiment, the electronic device 101 may include a plurality of microphones to detect the direction of sound. According to an embodiment, the electronic device 101 may include an audio module in which the speaker hole 247a and the microphone hole 247b are implemented as one hole, or may include a speaker (e.g., a piezo speaker) excluding the speaker hole 247a.

According to various embodiments, the camera modules 249a and 249b may include a first camera module 249a and a second camera module 249b. The second camera module 249b may be positioned in the first housing 201 and may photograph a subject in the opposite direction of the first display area A1 of the display 203. The electronic device 101 may include a plurality of camera modules 249a and 249b. For example, the electronic device 101 may include at least one of a wide-angle camera, a telephoto camera, or a macro camera and, depending on the embodiment, include an infrared projector and/or an infrared receiver to measure the distance to the subject. The camera modules 249a and 249b may include one or more lenses, an image sensor, and/or an image signal processor. The first camera module 249a may be disposed to face in the same direction as the display 203. For example, the first camera module 249a may be disposed around the first display area A1 or in an area overlapping the display 203 and, when disposed in an area overlapping the display 203, may photograph a subject through the display 203.

According to various embodiments, an indicator (not shown) of the electronic device 101 may be disposed in the first housing 201 or the second housing 202, and may include a light-emitting diode to provide state information of the electronic device 101 as a visual signal. A sensor module (not shown) of the electronic device 101 may generate an electrical signal or data value corresponding to an internal operating state of the electronic device 101 or an external environmental state. The sensor module may include, for example, a proximity sensor, a fingerprint sensor, or a biometric sensor (e.g., an iris/facial recognition sensor or an heart rate monitor (HRM) sensor). In another embodiment, a sensor module, for example, at least one of a gesture sensor, a gyro sensor, an atmosphere pressure sensor, a magnetic sensor, an acceleration sensor, a grip sensor, a color sensor, an infrared (IR) sensor, a temperature sensor, a humidity sensor, or an illuminance sensor may be included. According to an embodiment, the first housing 201 may include a first plate 211 and a slide cover (not shown). The first plate 211 and the slide cover (not shown) may be mounted (e.g., at least partially connected) to the second housing 202 and may reciprocate in a straight line in one direction (e.g., the direction of arrow \textcircled{1} in FIG. 2B) while being guided by the second housing 202. According to an embodiment, the first plate 211 may support the display 203. For example, the first plate 211 may include a first face F1, and the first display area A1 of the display 203 may be substantially positioned on the first face F1, remaining in a flat form. The slide cover may protect the display 203 positioned on the first plate 211. For example, at least a portion of the display 203 may be positioned between the first plate 211 and the slide cover. According to an embodiment, the first plate 211 and the slide cover may be made of a metal material and/or a non-metal (e.g., polymer) material. According to an embodiment, the first plate 211 may accommodate at least some (e.g., the battery 189 in FIG. 1, a motor (not shown), and a rack (not shown)) of the components of the electronic device 101. According to various embodiments, at least one or a plurality of substrates may be accommodated in the second housing 202. For example, the second housing 202 may include a circuit board (or main circuit board) (not shown), and the main circuit board may have a processor, memory, and/or an interface mounted thereon. The processor may include, for example, one or more of a central processing unit, an application processor, a graphics processing unit, an image signal processor, a sensor hub processor, or a communication processor. According to various embodiments, the circuit board may include a flexible printed circuit board-type radio frequency cable (FRC). For example, the circuit board may be disposed on at least a portion of the second plate 221, and may be electrically connected to an antenna module (e.g., the antenna module 197 in FIG. 1) and a communication module (e.g., the communication module 190 in FIG. 1).

According to an embodiment, the memory may include, for example, volatile memory or non-volatile memory.

According to an embodiment, the interface may include, for example, a high-definition multimedia interface (HDMI), a universal serial bus (USB) interface, an SD card interface, and/or an audio interface. For example, the interface may electrically or physically connect the electronic device 101 to an external electronic device and include a USB connector, an SD card/MMC connector, or an audio connector.

According to an embodiment, the electronic device 101 may further include a separate sub-circuit board spaced apart from the circuit board in the second housing 202. The sub-circuit board may be electrically connected to electrical components disposed at the end area of the electronic device 101, such as a battery, a speaker, and/or a SIM socket, to transmit signals and power.

According to an embodiment, the battery is a device for supplying power to at least one element of the electronic device 101, and may include, for example, a non-rechargeable primary battery, a rechargeable secondary battery, or a fuel cell. At least a portion of the battery may be disposed substantially on the same plane as, for example, the circuit board. The battery may be disposed integrally inside the electronic device 101, or may be disposed to be detachable from the electronic device 101.

According to an embodiment, the electronic device 101 may be disposed on the second housing 202 (e.g., the second plate 221), and may include a rack (not shown) for guiding the slide movement of the first housing 201 (e.g., the first plate 211) and a motor (not shown) for transmitting driving force to a gear (not shown) to rotate along the rack.

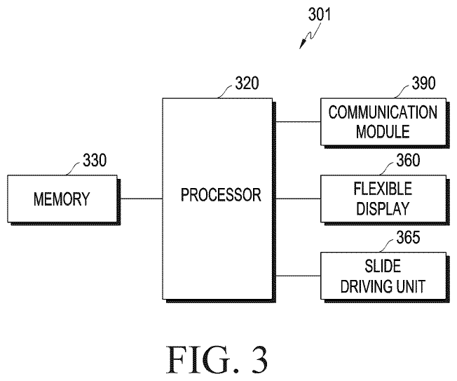

FIG. 3 may be a block diagram of an electronic device according to an embodiment.

Referring to FIG. 3, an electronic device 301 (e.g., the electronic device 101 in FIG. 1) according to an embodiment may include at least one processor 320, memory 330, a flexible display 360, a slide driving unit 365, and/or a communication module 390. The electronic device 301 according to an embodiment is not limited thereto and may be configured to further include various elements or exclude some of the elements. The electronic device 301 according to an embodiment may further include all or some of the electronic device 301 shown in FIG. 1.

The flexible display 360 (e.g., the display 160 in FIG. 1 or the display 203 in FIGS. 2A to 2B) (hereinafter also referred to as a display) according to an embodiment may be implemented in the form of a touch screen. In the case where the display 360 is implemented in the form of a touch screen together with an input module, it may display a variety of information generated according to the user's touch operation. According to an embodiment, the display 360 may be configured to be rollable in the slide-in or slide-out operation. According to an embodiment, based on the slide-in or slide-out operation of the display 360, the display 360 may switch to a first state (e.g., an expanded state) in which the screen on the display 360 is expanded to the maximum or a second state (e.g., a reduced state) in which the screen on the display 360 is reduced to the minimum. According to an embodiment, based on the slide-in or slide-out operation of the display 360, the display 360 may be in at least one partially expanded state in which the screen on the display 360 is expanded to at least one specified extension length between the minimum state and the maximum state thereof. According to an embodiment, at least one partially expanded state of the display 360 may indicate the state in which the screen is expanded to a specified extension length in relation to a specific display layout.

For example, the display 360 may move in a first direction (slide-out direction) relative to the first housing 201 and/or the second housing 202, thereby switching to an expanded state (e.g., partially expanded state or fully expanded state) in which at least a portion (e.g., A2) is exposed through the front face of the electronic device 101 from the inside of the first housing 201 and/or the second housing 202; the display 360 may switch to a reduced state in which at least a portion (e.g., A2) is not exposed through the front face of the electronic device 101 by moving the housing 202 from the first direction to the second direction (e.g., slide-in direction) opposite the first direction.

The slide driving unit 365 according to an embodiment may include a motor, a gear, and/or a rack, and enable the display 360 (e.g., the first housing 201) (or at least a portion (e.g., A2) of the display 203) to slide in or out through the motor, the gear, and/or the rack. According to an embodiment, the motor may be driven by receiving power (or current) to transmit driving force to a gear connected to the motor. The gear according to an embodiment may enable the display 360 to slide in or out in conjunction with the rack, based on the driving force from the motor.

The communication module 390 (e.g., the communication module 190 in FIG. 1) according to an embodiment, under the control of at least one processor 420, may communicate with an external electronic device 104 through a first network 198 (e.g., a short-range communication network such as Bluetooth, WiFi (wireless fidelity) direct, or infrared data association (IrDA)) or a second network 199 (e.g., a long-range communication network such as a legacy cellular network, a 5G network, a next-generation communication network (e.g., new radio access technology (NR)), the Internet, or a computer network (e.g., LAN or WAN)).

At least one processor 320 (e.g., the processor 120 in FIG. 1) according to an embodiment may control the overall operation of elements included in the electronic device 301.

The processor 320 according to an embodiment may display an application screen on the display 360, based on execution of an application (or referred to as content). For example, the processor 320 may execute each of a plurality of applications and execute a plurality of applications simultaneously. Applications according to an embodiment may include one of an email application (email), a video playback application (video), a calendar application (calendar), a gallery application (gallery), a note application (notes), an Internet application (internet), and/or various other applications executable in the electronic devices 301. According to an embodiment, the respective applications may include a plurality of view modes that are the same as or different from each other, or may not include specified view modes. When running an application, the processor 320 according to an embodiment may perform control, if the application includes a plurality of view modes, such that a screen according to one view mode (selected or specified) from among the plurality of view modes is to be displayed.

Table 1 below is a table showing examples of view modes for respective applications.

TABLE 1

| Application | 1st view | 2nd view | 3rd view | 4th view |
|---|---|---|---|---|
| Video | Mobile | TV | Movie | Sports |
| Gallery | Album | Split | | |
| Email | List | Drawer | Menu | |
| Notes | Read | Write | Drawing | |
| Calendar | Day | Week | Month | Year |
| Internet | Mobile | PC | | |

Referring to Table 1, the video playback application (video) according to an embodiment may include a mobile view mode, a TV view mode, a movie view mode, and a sports view mode. The gallery application (gallery) may include an album view mode and a split view mode. The note application (notes) may include a read view mode, a write view mode, and a drawing view mode. The email application (email) may include a list view mode, a drawer view mode, and a menu view mode. The calendar application (calendar) may include a day view mode, a week view mode, a month view mode, and a year view mode. The Internet application (internet) may include a mobile view mode and a PC view mode. The applications and the view modes of each application in Table 1 are only examples, and other applications may be further included, and other view modes of each application may also be included in addition to the above view modes. When executing an application, the processor 320 according to an embodiment, if the application does not include a specified view mode, may control an application screen to be displayed based on a view mode (e.g., a default view mode) configured in the electronic device 320, or may provide display screen size information and control a screen to be displayed according to the display screen size selected or specified through the display screen size information. When displaying a plurality of application screens on the display, the processor 320 according to an embodiment may provide view modes associated with displaying multiple application screens and control the multiple application screens to be displayed according to a selected or specified view mode.

The processor 320 according to an embodiment may identify the occurrence of a display event for a display mode option (or information) while displaying an application screen on the display 360, based on execution of the application. For example, the display mode option may include at least some or all of a plurality of view modes associated with the running application. For example, the display mode option may include at least one option regarding a changeable display mode of the display 360 and include at least one display mode selection UI object (e.g., graphical objects, buttons, or icons). For example, the processor 320 may identify a display event (e.g., a display request) for a display mode option, based on a specified key (e.g., 241) input event or an event generated by the application while displaying the application screen. The processor 320 according to an embodiment, based on the occurrence of a display event for a display mode option, may identify context information associated with the electronic device 301 (or the user of the electronic device 301). For example, the context information may include the location (current location), time (current time), and/or view mode (current view mode) associated with the electronic device 301 (or user of electronic device 301). For example, the location associated with the electronic device 301 (or the user of the electronic device 301) may be the location of the electronic device 301 (or the user) while the application screen is displayed. For example, the time associated with the electronic device 301 (or the user of the electronic device 301) may be the time at which the application screen is displayed. For example, the view mode associated with the electronic device 301 (or the user of the electronic device 301) may be the view mode while the application screen is displayed.

The processor 320 according to an embodiment, based on the context information during the display of the application screen, may display a display mode option including at least some or all of the view modes of the application. For example, the context information may be one of a plurality of different context information.

According to an embodiment, if the application includes a first view mode, a second view mode, and a third view mode, and if the first context information includes a first location, a first time, and a first view mode, the processor 320 may display, as a first display mode option corresponding to the first location, first time, and first view mode, a current first view mode button (or icon or image) and a second view mode button (or icon or image) that enables switching corresponding to the first location and first time. For example, the current first view mode button and the second view mode button may be displayed in different ways. For example, the current first view mode button may be controlled to be displayed dimly (or to be small or shaded) and the second view mode button may be controlled to be displayed clearly (or to be large or unshaded). According to an embodiment, the processor 320 may perform control to display only the second view mode button, instead of the first view mode button.

The processor 320 according to an embodiment may receive a selection for the second view mode button included in the first display mode option (e.g., a selection using a touch input or another type of input) and perform a display operation based on the second view mode according to the selected second view mode button. According to an embodiment, when the display operation based on the second view mode is completed after the second view mode button is selected, the display of the first display mode information may end.

The processor 320 according to an embodiment may identify a change in the context information while displaying an application screen. For example, if first context information is changed to second context information while displaying the application screen, the processor 320 may perform control to display a second display mode option corresponding to the second context information. For example, if the application includes a first view mode, a second view mode, and a third view mode, and if the second context information includes a second location, a second time, and a second view mode, the processor 320 may display, as a second display mode option corresponding to the second position, second time, and second view mode, a current second view mode button and a third view mode button that enables switching corresponding to the second location and second time.

Table 2 below is a table showing examples of display mode information based on context information of an application including a plurality of view modes.

TABLE 2

| | Context information | | | | Display | View |
|---|---|---|---|---|---|---|
| | | | | View | mode | mode |
| Applications | | Location | Time | modes | option | button |
| Video | 1st context | Home | 6 pm | x | 1st display | Mobile/TV/ |
| | information | | to 9 | | mode | Movie/ |
| | | | am | | option | Sports |
| | 2nd | Company | 9 am | x | 2nd display | Mobile/TV |
| | context | | to 6 | | mode | |
| | information | | pm | | option | |
| | 3rd context | Moving | x | x | 3rd display | Mobile/TV/ |
| | information | at high | | | mode | Movie/ |
| | | speed | | | option | Sports |
| Gallery | 1st context | Home | 6 pm | Split | 1st display | Album |
| | information | | to 9 | | mode | |
| | | | am | | option | |
| | 2nd | Company | 9 am | Album | 2nd display | Split |
| | context | | to 6 | | mode | |
| | information | | pm | | option | |
| | 3rd context | x | x | Album/ | 3rd display | Thumbnail/ |
| | information | | | Split | mode | Navigation/ |
| | | | | | option | Full |
| | | | | | | screen |
| Email | 1st context | Home | 6 pm | List | 1st display | List/ |
| | information | | to 9 | | mode | Drawer/ |
| | | | am | | option | Menu |
| | 2nd | Company | 9 am | Drawer | 2nd display | List/ |
| | context | | to 6 | | mode | Drawer/ |
| | information | | pm | | information | Menu |
| | 3rd context | x | x | Split/ | 3rd display | List/ |
| | information | | | Content/ | mode | Navigation/ |
| | | | | View | option | Full |
| | | | | | | screen |
| Notes | 1st context | x | x | Read | 1st display | Write/ |
| | information | | | | mode | Drawing |
| | | | | | option | |
| | 2nd | x | x | Write | 2nd display | Read/ |
| | context | | | | mode | Drawing |
| | information | | | | information | |
| | 3rd context | x | x | Drawing | 3rd display | Read/ |
| | information | | | | mode | Write |
| | | | | | option | |
| Calendar | 1st context | Home | 6 pm | Day | 1st display | Day/Week/ |
| | information | | to 9 | | mode | Month/Year |
| | | | am | | option | |
| | 2nd | Company | 9 am | Week | 2nd display | Day/Week/ |
| | context | | to 6 | | mode | Month/Year |
| | information | | pm | | information | |
| | 3rd context | x | x | Month | 3rd display | List/ |
| | information | | | | mode | Navigation/ |
| | | | | | option | Full |
| | | | | | | screen |
| Internet | 1st context | Home | 6 pm | Mobile | 1st display | PC |
| | information | | to 9 | | mode | |
| | | | am | | option | |
| | 2nd | Company | 9 am | PC | 2nd display | Mobile |
| | context | | to 6 | | mode | |
| | information | | pm | | information | |
| | 3rd context | x | x | Mobile/ | 3rd display | Mobile/PC |
| | information | | | PC | mode | |
| | | | | | option | |

Referring to Table 2, the processor 320 according to an embodiment may identify context information (e.g., first context information, second context information, third context information, or other context information) while displaying a video playback application (video) screen and, based on the identified context information, display a display mode option (e.g., a first display mode option, a second display mode option, a third display mode option, or another display mode option) corresponding thereto on the display 360. For example, if first context information indicating that the electronic device 301 (or the user) is located at home, that the time is between 6 pm and 9 am, and that the current view mode is not specified (or is a default view mode) is identified as context information while displaying a video playback application (video) screen, the processor 320 may display, on the display 360, a mobile view button, a TV view button, a movie view button, and a sports view button, based on the first display mode option. As another example, if second context information indicating that the electronic device 301 (or the user) is located at home, that the time is between 9 am and 6 pm, and that the current view mode is not specified (or is a default view mode) is identified as context information while displaying a video playback application (video) screen, the processor 320 may display, on the display 360, a mobile view button and a TV view button, based on the second display mode option. As another example, if third context information indicating the state in which the electronic device 301 (or the user) is moving at high speed is identified as context information while displaying a video playback application (video) screen, the processor 320 may display, on the display 360, a mobile view button, a TV view button, a movie view button, and a sports view button, based on the third display mode option. Although the first to third context information is shown in Table 1 as an example of the context information for the video playback application (video), the above example is only an embodiment, and the context information may include other location, time, and/or view mode conditions, and the display mode option may also differ between the respective context information. The processor 320 according to an embodiment, like the video playback application (video), may display different view mode buttons, based on different display mode options corresponding to different context information, while displaying application screens for the gallery application (gallery), the note application (notes), the email application (email), the calendar application (calendar), and/or the Internet application (Internet), respectively. The memory 330 according to an embodiment may store application programs and data. For example, the memory 330 may store at least one application (function or program). The memory 330 according to an embodiment may store programs (e.g., the programs 140 in FIG. 1) used for functional operation and a variety of data generated during execution of the programs 140. The memory 330 may largely include a program area 140 and a data area (not shown). The program area 140 may store program information related to driving the electronic device 301, such as an operating system (OS) (e.g., the operating system 142 in FIG. 1) that boots the electronic device 301. The data area (not shown) may store transmitted and/or received data and generated data according to various embodiments. In addition, the memory 330 may be configured to include at least one storage medium from among flash memory, a hard disk, multimedia card micro-type memory (e.g., secure digital (SD) or extreme digital (XD) memory), RAM, and ROM.

According to an embodiment, the electronic device 301 is not limited to the configuration shown in FIG. 3, and may be configured to further include various elements. According to an embodiment, the electronic device 301 may further include an image processing module (not shown). The image processing module may perform a 2D or 3D image processing and/or rendering operation under the control of the processor 320.

In the above embodiment, the primary elements of the electronic device have been described with reference to the electronic device 301 in FIG. 3. However, in various embodiments, not all of the elements shown in FIG. 3 are essential elements, and the electronic device 301 may be implemented with more or fewer elements than the illustrated elements.

According to various embodiments, an electronic device (e.g., the electronic device 101 in FIGS. 1, 2A, and 2B or the electronic device 301 in FIG. 3) may include a housing (e.g., the first housing 201 and the second housing 202 in FIGS. 2A and 2B), a flexible display (e.g., the display 160 in FIGS. 1, 2A, and 2B or the display 360 in FIG. 3) connected to the housing, a slide driving unit (e.g., the slide driving unit 365 in FIG. 3) configured to slide the flexible display in an extension direction or reduction direction, and at least one processor operably connected to the flexible display and the slide driving unit, wherein the at least one processor (e.g., the processor 120 in FIG. 1 or the processor 320 in FIG. 3) may be configured to identify, based on execution of an application, a display event for a display mode option while displaying a screen of the application on the flexible display, identify first context information, based on context information associated with the electronic device, according to the display event for the display mode option, display a first display mode option including at least some or all of the view modes associated with the application or the electronic device, based on the first context information, identify second context information, based on a change in the context information associated with the electronic device, and display a second display mode option different from the first display mode option, based on the second context information.

According to various embodiments, the display event may be configured to include a specified key input event or an event generated by the application while displaying a screen of the application.

According to various embodiments, the context information associated with the electronic device may include at least one of a location, a time, and a view mode associated with the electronic device.

According to various embodiments, each of the first display mode option and the second display mode option may include at least one view mode button.

According to various embodiments, each of the first display mode option and the second display mode option may further include at least one of a display screen size indicator (or information) or a display direction indicator (or information).

According to various embodiments, the at least one processor may be configured to perform a display operation corresponding to a view mode button selected from among the at least one view mode button, or may be configured to adjust the display screen size by controlling the flexible display to slide in the extension direction or the reduction direction in response to the selected view mode button.

According to various embodiments, the at least one view mode button may include a plurality of view mode buttons, and the at least one processor may be configured to display a first view mode button corresponding to a current view mode, among the plurality of view mode buttons, in a first display scheme and display a second view mode button not corresponding to the current view mode in a second display scheme.

According to various embodiments, the first view mode button may be a view mode button corresponding to a first display screen size, and the second view mode button may be a view mode button corresponding to a second display screen size.

According to various embodiments, the at least one processor may be configured to identify whether to display multiple application screens on the flexible display and display a multi-display mode option when displaying the multiple application screens, and the multi-display mode option may include at least one of an overlay view mode button, a pop-up view mode button, a horizontal view mode button, or a vertical view mode button.

According to various embodiments, the at least one processor may be configured to identify whether to provide the display mode option using usage history information related to the usage history of application, based on the display event for the display mode option, and, when it is identified that the display mode option is to be provided using the usage history information, provide the display mode option including a view mode button most recently used for the application.

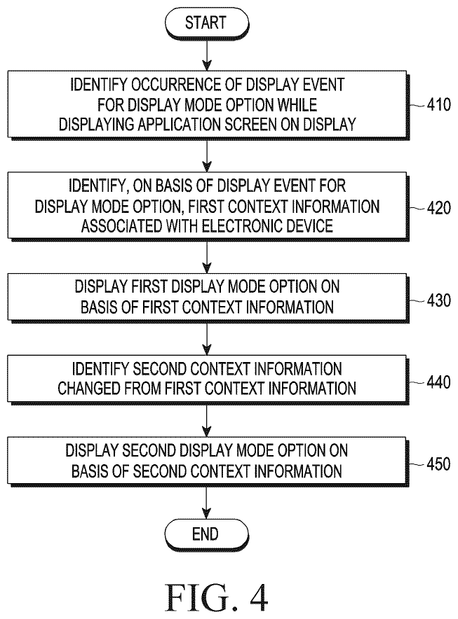

FIG. 4 is a flowchart illustrating an operation of displaying a display mode option in an electronic device according to an embodiment.

Referring to FIG. 4, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may perform at least one of operations 410 to 450.

In operation 410, the processor 320 according to an embodiment may identify the occurrence of a display event for a display mode option while displaying an application screen on the display 360. For example, the display mode option may include at least some or all of a plurality of view modes associated with a running application, or at least one some or all of selectable view modes provided from the electronic device 301, regardless of the type of application. For example, the processor 320 may identify a display request for a display mode option, based on a specified key (e.g., 241) input event or an event generated by the application while displaying the application screen.

In operation 420, the processor 320 according to an embodiment, based on the occurrence of a display event for a display mode option, may identify context information (e.g., a first context information) associated with the electronic device 301 (or the user of the electronic device 301). For example, the first context information may include the location (current location), time (current time), and/or view mode (current view mode) associated with the electronic device 301 (or user of electronic device 301). For example, the location associated with the electronic device 301 (or the user of the electronic device 301) may be the location of the electronic device 301 (or the user) while the application screen is displayed. For example, the time associated with the electronic device 301 (or the user of the electronic device 301) may be the time at which the application screen is displayed. For example, the view mode associated with the electronic device 301 (or the user of the electronic device 301) may be the view mode while the application screen is displayed.

In operation 430, the processor 320 according to an embodiment may display a first display mode option based on the first context information. For example, the processor 320, based on the first context information, may display a first display mode option including at least some or all of the view modes of the application or at least some or all of the view modes provided by the electronic device 301, regardless of the application. For example, if the application or the view modes provided by the electronic device 301 include a first view mode, a second view mode, and a third view mode, and if the first context information includes a first location, a first time, and a first view mode, the processor 320 may display, as a first display mode option corresponding to the first location, first time, and first view mode, a current first view mode button and a second view mode button that enables switching corresponding to the first location and first time. For example, the current first view mode button and the second view mode button may be displayed in different ways. For example, the current first view mode button may be controlled to be displayed dimly (or to be small or shaded), and the second view mode button may be controlled to be displayed clearly (or to be large or unshaded). According to an embodiment, the processor 320 may display only the second view mode button, instead of the first view mode button. The processor 320 according to an embodiment may receive a selection for the second view mode button included in the first display mode option (e.g., a selection using a touch input or another type of input) and perform a display operation based on the second view mode according to the selected second view mode button.

In operation 440, the processor 320 according to an embodiment may identify a change in the context information while displaying the application screen. For example, the processor 320 may identify the context information continuously, periodically for a specified period, according to user input, or at a time specified by the application (or settings of the electronic device 301) while displaying the application screen based on a specific view mode, and identify whether or not the context information changes from the first context information to the second context information. For example, the processor 320 may identify that at least one of the first location, the first time, and/or the first view mode associated with the electronic device 301 (or the user of the electronic device 301) changes to a second location, a second time, and/or a second view mode.

In operation 450, the processor 320 according to an embodiment may display a second display mode option, based on the second context information. For example, if the application or the view modes provided by the electronic device 301 include a first view mode, a second view mode, and a third view mode, and if the second context information includes a second location, a second time, and a second view mode, the processor 320 may display, as a second display mode option corresponding to the second location, second time, and second view mode, a current second view mode button and a third view mode button that enables switching corresponding to the second location and second time.

According to various embodiments, a method of displaying display mode information, based on context information, in an electronic device (e.g., the electronic device 101 in FIGS. 1, 2A, and 2B or the electronic device 301 in FIG. 3) may include, based on execution of an application, identifying a display event for a display mode option while displaying a screen of the application on a flexible display, identifying first context information based on context information associated with the electronic device, according to the display event for the display mode option, displaying a first display mode option including at least some or all of the view modes associated with the application or the electronic device, based on the first context information, identifying second context information, based on a change in the context information associated with the electronic device, and displaying a second display mode option different from the first display mode option, based on the second context information.

According to various embodiments, the display event may include a specified key input event or an event generated by the application while displaying the screen of the application.

According to various embodiments, the context information associated with the electronic device may include at least one of a location, a time, and a view mode associated with the electronic device.

According to various embodiments, each of the first display mode option and the second display mode option may include at least one view mode button, and the method may include displaying a view mode corresponding to a view mode button selected from among the at least one view mode button, and the displaying of the view mode corresponding to the selected view mode button may include adjusting the display screen size by controlling the flexible display of the electronic device to slide in the extension direction or the reduction direction in response to the view mode corresponding to the selected view mode button.

According to various embodiments, in the method, each of the first display mode option and the second display mode option may further include at least one of a display screen size indicator or a display direction indicator.

According to various embodiments, the at least one view mode button may include a plurality of view mode buttons, and the method may further include displaying a first view mode button corresponding to a current view mode, among the plurality of view mode buttons, in a first display scheme and displaying a second view mode button not corresponding to the current view mode in a second display scheme.

According to various embodiments, the first view mode button may be a view mode button corresponding to a first display screen size, and the second view mode button may be a view mode button corresponding to a second display screen size.

According to various embodiments, the method may further include identifying whether to display multiple application screens on the flexible display, and displaying a multi-display mode option when displaying the multiple application screens, and the multi-display mode option may include at least one of an overlay view mode button, a pop-up view mode button, a horizontal view mode button, or a vertical view mode button.

According to various embodiments, the method may further include identifying whether to provide the display mode option using usage history information related to the usage history of application, based on the display event for the display mode option, and, if it is identified that the display mode option is to be provided using the usage history information, providing a display mode option including a view mode button most recently used for the application.

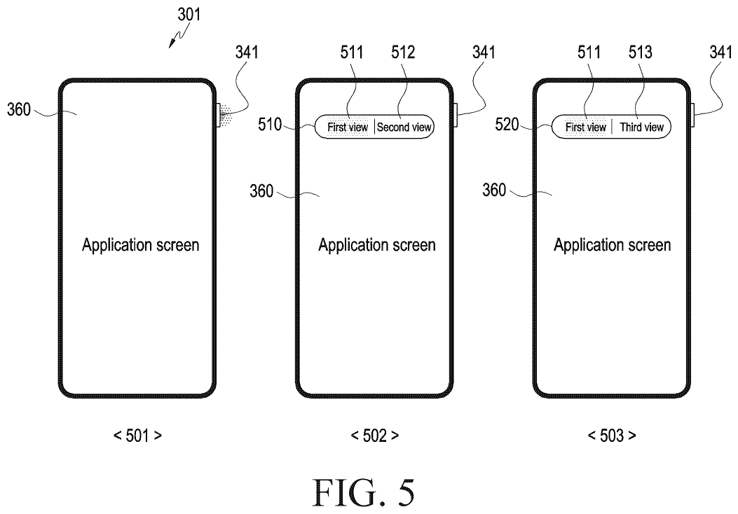

FIG. 5 is a diagram illustrating an example of displaying a display mode option in an electronic device according to an embodiment.

Referring to FIG. 5, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying an application screen on the display 360, based on execution of an application, as shown in <501>. For example, the processor 320 may identify a display request for a display mode option, based on input (or touch or press) onto a specified key 341, while displaying the application screen.

The processor 320 according to an embodiment may identify context information (e.g., first context information) associated with the electronic device 301 (or the user of the electronic device 301), based on the input to the specified key 341. For example, the first context information may include the location (current location), time (current time), and/or view mode (current view mode) associated with the electronic device 301 (or user of electronic device 301). For example, the location associated with the electronic device 301 (or the user of the electronic device 301) may be the location of the electronic device 301 (or the user) while the application screen is displayed. For example, the time associated with the electronic device 301 (or the user of the electronic device 301) may be the time at which the application screen is displayed. For example, the view mode associated with the electronic device 301 (or the user of the electronic device 301) may be the view mode while the application screen is displayed. The processor 320 according to an embodiment may display a first display mode option 510 including at least some or all of the view modes of the application, based on the first context information, on the display 360 as shown in <502>. For example, if the view modes of the application include a first view mode, a second view mode, and a third view mode, and if the first context information includes a first location, a first time, and a first view mode, the processor 320 may display, as a first display mode option 510 corresponding to the first location, first time, and first view mode, a current first view mode button (or icon or image) 511 and a second view mode button 512 that enables switching from the first view mode corresponding to the first location and first time. For example, the current first view mode button 511 and the second view mode button (or icon or image) 512 may be displayed in different ways. For example, the current first view mode button 511 may be controlled to be displayed dimly (or to be small or shaded), and the second view mode button 512 may be controlled to be displayed clearly (or to be large or unshaded). According to an embodiment, the processor 320 may display only the second view mode button 512, instead of the first view mode button 511. The processor 320 according to an embodiment may receive a selection for the second view mode button 512 included in the first display mode option 510 (e.g., a selection using a touch input or another type of input) and perform a display operation, based on the second view mode according to the selected second view mode button 512.

The processor 320 according to an embodiment may identify a change in the context information while displaying an application screen. For example, if the first context information changes to the second context information while displaying the application screen, the processor 320 may perform control to display a second display mode option 520 corresponding to the second context information on the display 360, as shown in <503>. For example, if the application includes a first view mode, a second view mode, and a third view mode, and if the second context information includes a second location, a second time, and a second view mode, the processor 320 may display, as a second display mode option corresponding to the second position, second time, and second view mode, a current second view mode button 511 and a third view mode button 513 indicating the third view mode that may be switched from the second view mode, based on the second context information.

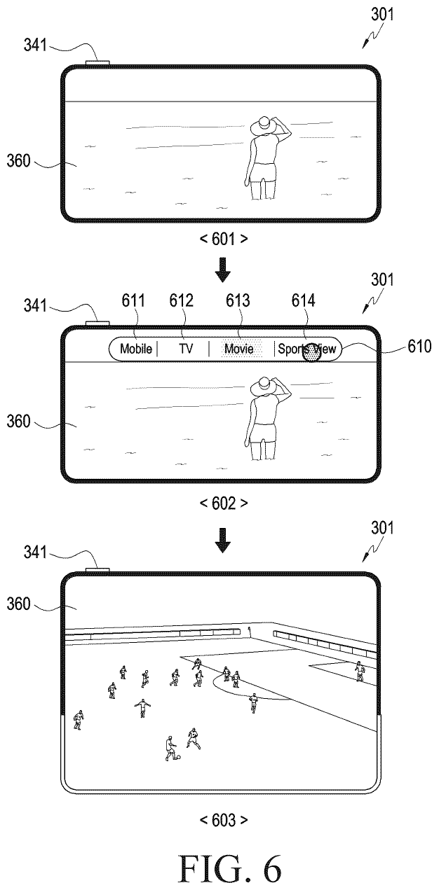

FIG. 6 is a diagram illustrating an example of displaying a display mode option when displaying a video playback application (video) screen in an electronic device according to an embodiment.

Referring to FIG. 6, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying a video playback application (video) screen on the display 360, based on execution of a video playback application (video), as shown in <601>. For example, the processor 320 may identify a display request for a display mode option, based on input (or touch or press) onto a specified key 341, while displaying the application screen.

The processor 320 according to an embodiment may identify context information associated with the electronic device 301 (or the user of the electronic device 301), based on the input to the specified key 341. For example, the processor 320 may identify context information indicating that the electronic device 301 (or the user) is at home, that the time is between 6 pm and 9 am, and that the current view mode is a movie view, based on the input to the specified key 341 while displaying the video playback application (video) screen. Alternatively, other context information may be identified. The processor 320 according to an embodiment, based on the identified context information, may display, on the display 360, display mode information 610 corresponding to the identified context information as shown in <602>. For example, if context information indicating that the view modes of the video playback application (video) include a mobile view, a TV view, a movie view, and a sports view, that the electronic device 301 (or the user) is at home, that the time is between 6 pm and 9 am, and that the current view mode is a movie view is identified, the processor 320 may display, as a display mode option 610, a current movie view mode button 613 and at least one or more view mode buttons (e.g., a mobile view mode button 611, a TV view mode button 612, and a sports view mode button 614) that enables switching from the movie view mode. For example, the current movie view mode button 613 and at least one or more view mode buttons (e.g., the mobile view mode button 611, the TV view mode button 612, and the sports view mode button 614) may be displayed in different ways. For example, the current movie view mode button 613 may be controlled to be displayed dimly (or to be small or shaded), and at least one or more view mode buttons (e.g., the mobile view mode button 611, the TV view mode button 612, and the sports view mode button 614) may be controlled to be displayed clearly (or to be large or unshaded). According to an embodiment, the processor 329 may display only at least one or more view mode buttons (e.g., the mobile view mode button 611, the TV view mode button 612, and the sports view mode button 614), instead of the current movie view mode button 613. The processor 320 according to an embodiment may receive a selection (e.g., a selection using a touch input or another type of input) for one (e.g., the sports view mode button 614) of the at least one or more view mode buttons (e.g., the mobile view mode button 611, the TV view mode button 612, and the sports view mode button 614) included in the display mode option 610 and perform a display operation according to a sports view mode based on the selection for the sports view mode button 614 as shown in <603>. For example, the processor 320 may switch the display 360 to a partially expanded state or expanded state according to the sports view mode, and display a video playback application (video) screen on the partially expanded or expanded screen.

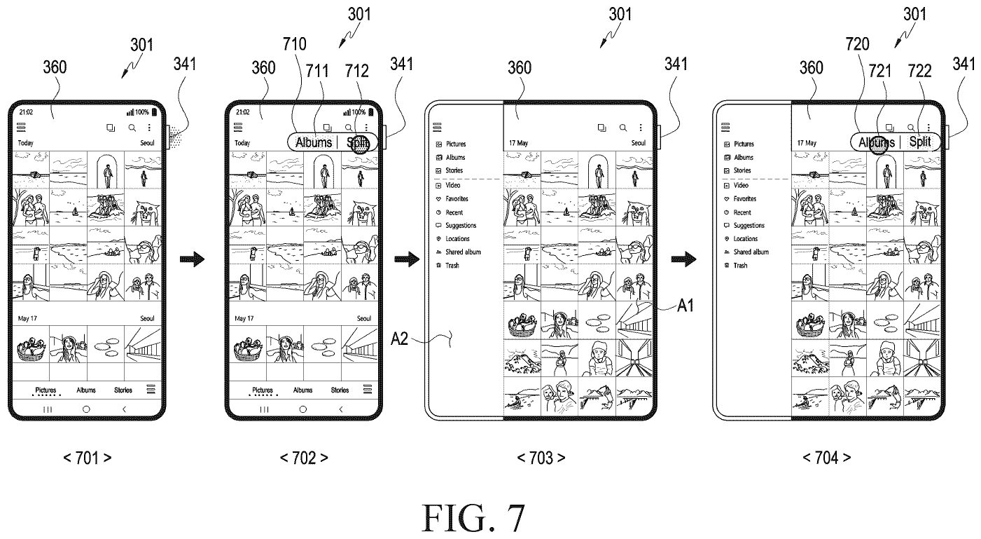

FIG. 7 is a diagram illustrating an example of display mode option when displaying a gallery application screen in an electronic device according to an embodiment.

Referring to FIG. 7, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying a gallery application (gallery) screen on the display 360, based on execution of a gallery application (gallery), as shown in <701>. For example, the processor 320 may identify a display request for a display mode option, based on input (or touch or press) onto a specified key 341, while displaying the application screen.

The processor 320 according to an embodiment may identify context information associated with the electronic device 301 (or the user of the electronic device 301), based on the display request for a display mode option. For example, the processor 320 may identify context information indicating that the electronic device 301 (or the user) is at a company, that the time is between 9 am and 6 pm, and that the current view mode is an album view while displaying the gallery application (gallery) screen. Alternatively, other context information may be identified. The processor 320 according to an embodiment, based on the identified context information, may display, on the display 360, a display mode option 710 corresponding to the identified context information as shown in <702>. For example, if context information indicating that the view modes of the gallery application (gallery) include an album view and a split view, that the electronic device 301 (or the user) is at a company, that the time is between 9 am and 6 pm, and that the current view mode is an album view is identified, the processor 320 may display, as a display mode option 710, a current album view mode button 711 and a split view mode button 712 that enables switching from the album view mode. For example, the current album view mode button 711 and the split view mode buttons 712 may be displayed in different ways. For example, the current album view mode button 711 may be controlled to be displayed dimly (or to be small or shaded), and the split view mode button 712 may be controlled to be displayed clearly (or to be large or unshaded). According to an embodiment, the processor 320 may display only the split view mode button 712, instead of the current album view mode button 711. The processor 320 according to an embodiment may receive a selection (e.g., a selection using a touch input or another type of input) for the split view mode button 712 included in the display mode option 710 and perform a display operation according to a split view mode based on the selection for the split view mode button 712 as shown in <703>. For example, the processor 320 may switch the display 360 to an expanded state according to the split view mode, split the screen into a first display area A1 and a second display area A2 in the expanded state, display an album in the first display area A1, and display menus related to the gallery application (gallery) in the second display area A2.

The processor 320 according to an embodiment may identify a change in the context information while displaying an application screen according to the split view mode. For example, if the context information changes such that the electronic device 301 (or the user) is located at home, that the time is between 6 pm and 9 am, and that the current view mode is a split view mode, the processor 320 may display, as display mode information 720, a current split view mode button 722 and an album view mode button 721 that enables switching from the split view mode as shown in <704>. For example, the current split view mode button 722 and the album view mode buttons 721 may be displayed in different ways. For example, the current split view mode button 722 may be controlled to be displayed dimly (or to be small or shaded), and the album view mode buttons 721 may be controlled to be displayed clearly (or to be large or unshaded). According to an embodiment, the processor 320 may display only the album view mode buttons 721, instead of the current split view mode button 722.

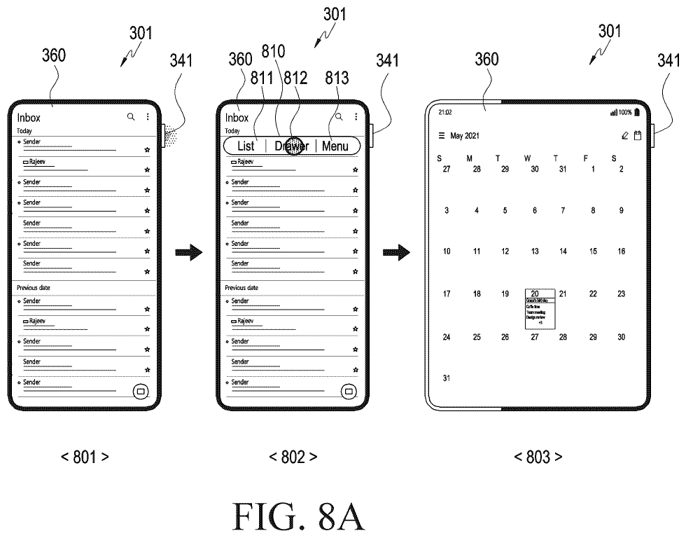

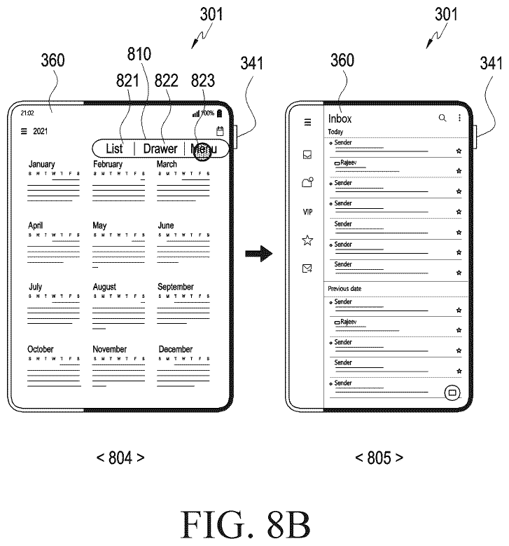

FIG. 8A is a diagram illustrating an example of displaying a display mode option when displaying an email application screen in an electronic device according to an embodiment.

Referring to FIG. 8A, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for display mode information while displaying an email application (email) screen on the display 360, based on execution of an email application (email), as shown in <801>. For example, the processor 320 may identify a display request for a display mode option, based on input (or touch or press) onto a specified key 341, while displaying the application screen.

The processor 320 according to an embodiment may identify context information associated with the electronic device 301 (or the user of the electronic device 301), based on the display request for a display mode option. For example, the processor 320 may identify context information indicating that the electronic device 301 (or the user) is at home, that the time is between 6 pm and 9 am, and that the current view mode is a list view mode while displaying the email application (email) screen. Alternatively, other context information may be identified. The processor 320 according to an embodiment, based on the identified context information, may display, on the display 360, display mode information 810 corresponding to the identified context information as shown in <802>. For example, if context information indicating that the view modes of the email application (email) include a list view mode, a drawer view mode, and a menu view mode, that the electronic device 301 (or the user) is at home, that the time is between 6 pm and 9 am, and that the current view mode is a list view mode is identified, the processor 320 may display, as display mode information 810, a current list view mode button 811, along with a drawer view mode button 812 and a menu view mode button 813 that enable switching from the list view mode. For example, the current list view mode button 811 and other buttons 812 and 813 may be displayed in different ways. For example, the list view mode button 811 may be controlled to be displayed dimly (or to be small or shaded), and other buttons 812 and 813 may be controlled to be displayed clearly (or to be large or unshaded). According to an embodiment, the processor 320 may display only the drawer view mode button 812 and the menu view mode button 813, instead of the current list view mode button 811. The processor 320 according to an embodiment may receive a selection (e.g., a selection using a touch input or another type of input) for one (e.g., the drawer view mode button 812) of the drawer view mode button 812 and the menu view mode button 813 in the display mode option 810 and perform a display operation according to a drawer view mode based on the selection for the drawer view mode button 812 as shown in <803>. For example, the processor 320 may switch the display 360 to an expanded state according to the drawer view mode and display an email application (email) screen in the expanded display area in the expanded state.

FIG. 8B is a diagram illustrating an example of displaying display mode option while displaying an email application (email) screen according to an email drawer view mode in an electronic device according to an embodiment.

Referring to FIG. 8B, the processor 320 according to an embodiment may identify a change in the context information while displaying an email application (email) screen according to the drawer view mode shown in <803> in FIG. 8A. For example, if the context information changes such that the electronic device 301 (or the user) is located at a company, that the time is between 9 am and 6 pm, and that the current view mode is a drawer view mode, the processor 320 may display, as display mode information 820, a current drawer view mode button 822 and a list view mode button 821 and a menu view mode button 823 that enable switching from the drawer view mode as shown in <804>. For example, the current drawer view mode button 822, the list view mode button 821, and the menu view mode button 823 may be displayed in different ways. For example, the drawer view mode button 822 may be controlled to be displayed dimly (or to be small or shaded), and the list view mode button 821 and the menu view mode button 823 may be controlled to be displayed clearly (or to be large or unshaded). According to an embodiment, the processor 320 may display only the list view mode button 821 and the menu view mode button 823, instead of the current drawer view mode button 822.

The processor 320 according to an embodiment may receive a selection (e.g., a selection using a touch input or another type of input) for one (e.g., the menu view mode button 813) of the list view mode button 811 and the menu view mode button 813 in the display mode option 810 and perform a display operation according to a menu view mode based on the selection for the menu view mode button 813 as shown in <805>. For example, the processor 320 may switch the display 360 to a partially expanded state according to the menu view mode and display email-related menus in the partially expanded display area in the partially expanded state.

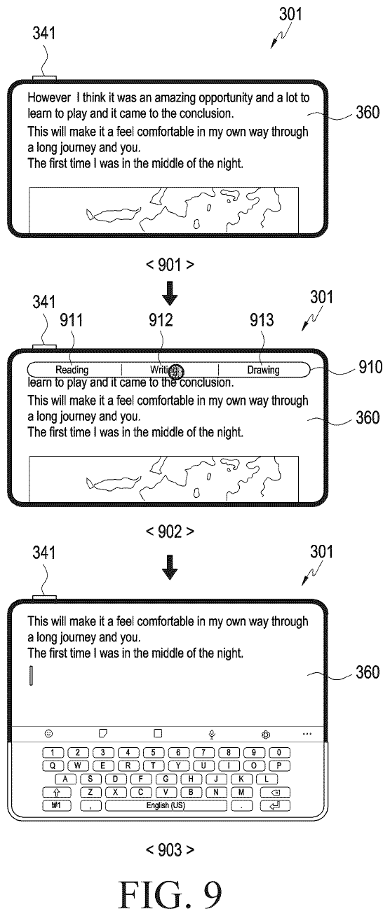

FIG. 9 is a diagram illustrating an example of displaying a display mode option when displaying a note application (notes) screen in an electronic device according to an embodiment.

Referring to FIG. 9, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying a note application (notes) screen on the display 360, based on execution of a note application (notes), as shown in <901>. For example, the processor 320 may identify a display request for a display mode option, based on input (or touch or press) onto a specified key 341, while displaying the application screen.

The processor 320 according to an embodiment may identify context information associated with the electronic device 301 (or the user of the electronic device 301), based on the display request for a display mode option. For example, the processor 320 may identify context information indicating that the current view mode is a read view mode while displaying the note application (notes) screen. Alternatively, other context information may be identified. The processor 320 according to an embodiment, based on the identified context information, may display, on the display 360, a display mode option 910 corresponding to the identified context information as shown in <902>. For example, if context information indicating that the view modes of the note application (notes) include a read view mode, a write view mode, and a drawing view mode and that the current view mode is a read view mode is identified, the processor 320 may display, as a display mode option 910, a current read view mode button 911, along with a write view mode button 912 and a drawing view mode button 913 that enable switching from the read view mode. For example, the current read view mode button 911, and other buttons 912 and 913 may be displayed in different ways. For example, the read view mode button 911 may be controlled to be displayed dimly (or to be small or shaded), and other buttons 912 and 913 may be controlled to be displayed clearly (or to be large or unshaded). According to an embodiment, the processor 320 may display only the write view mode button 912 and the drawing view mode button 913, instead of the current read view mode button 911. The processor 320 according to an embodiment may receive a selection (e.g., a selection using a touch input or another type of input) for one (e.g., the write view mode button 912) of the write view mode button 912 and the drawing view mode button 913 in the display mode option 910 and perform a display operation according to a write view mode based on the selection for the write view mode button 912 as shown in <903>. For example, the processor 320 may switch the display 360 to an expanded state according to the write view mode and display a note application (notes) screen in the expanded display area in the expanded state.

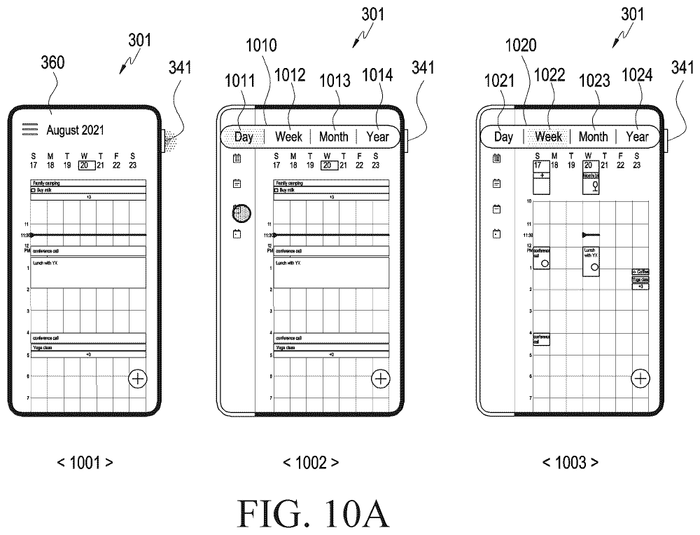

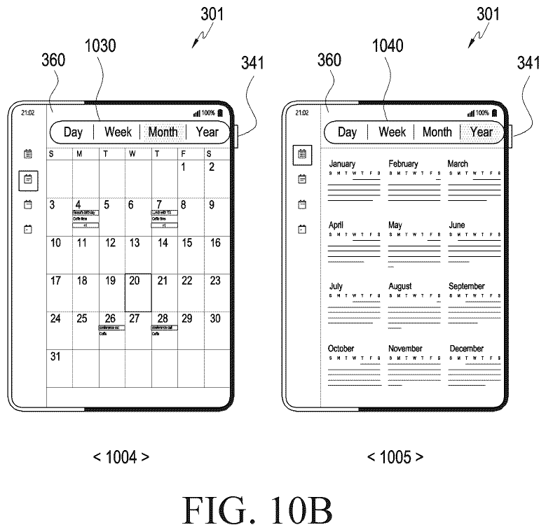

FIG. 10A is a diagram illustrating an example of displaying a display mode option when displaying a calendar application (calendar) screen in an electronic device according to an embodiment.

Referring to FIG. 10A, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying a calendar application (calendar) screen on the display 360, based on execution of a calendar application (calendar), as shown in <1001>. For example, the processor 320 may identify a display request for a display mode option, based on input (or touch or press) onto a specified key 341, while displaying the application screen.

The processor 320 according to an embodiment may identify context information associated with the electronic device 301 (or the user of the electronic device 301), based on the display request for a display mode option. For example, the processor 320 may identify context information indicating that the electronic device 301 (or the user) is at home, that the time is between 6 pm and 9 am, and that the current view mode is a day view mode while displaying the calendar application (calendar) screen. Alternatively, other context information may be identified. The processor 320 according to an embodiment, based on the identified context information, may display, on the display 360, a display mode option 1010 corresponding to the identified context information as shown in <1002>. For example, if context information indicating that the view modes of the calendar application (calendar) include a day view mode, a week view mode, a month view mode, and a year view mode, that the electronic device 301 (or the user) is at home, that the time is between 6 pm and 9 am, and that the current view mode is a day view mode is identified, the processor 320 may display, as a display mode option 1010, a current day view mode button 1011 along with a week view mode button 1012, a month view mode button 1013, and a year view mode button 1014 that enable switching from the day view mode. For example, the current day view mode button 1011, and other buttons 1012 to 1014 may be displayed in different ways. For example, the day view mode button 1011 may be controlled to be displayed dimly (or to be small or shaded), and other buttons 1012 to 1014 may be controlled to be displayed clearly (or to be large or unshaded). According to an embodiment, the processor 320 may display only the week view mode button 1012, the month view mode button 1013, and the year view mode button 1014, instead of the current day view mode button 1011. The processor 320 according to an embodiment may receive a selection (e.g., a selection using a touch input or another type of input) for one (e.g., the week view mode button 1012) of the week view mode button 1012, the month view mode button 1013, and the year view mode button 1014 in the display mode option 1010 and perform a display operation according to a week view mode based on the selection for the week view mode button 1012 as shown in <1003>. For example, the processor 320 may switch the display 360 to a partially expanded state according to the week view mode and display a calendar application (calendar) screen in the partially expanded display area in the partially expanded state. The processor 320 according to an embodiment may identify a change in the context information while displaying the calendar application (calendar) screen according to the week view mode shown in <1003>. According to an embodiment, if the context information changes such that the electronic device 301 (or the user) is located at a company, that the time is between 9 am and 6 pm, and that the current view mode is a week view mode, the processor may display, as a display mode option 1020, a current week view mode button 1022, along with the day view mode button 1011, the month view mode button 1013, and the year view mode button 1014 corresponding to view modes that may be switched from the week view mode as shown in <1003>. For example, the current week view mode button 1022, the day view mode button 1011, the month view mode button 1013, and the year view mode button 1014 may be displayed in different ways. For example, the week view mode button 1022 may be controlled to be displayed dimly (or to be small or shaded), and the day view mode button 1011, the month view mode button 1013, and the year view mode button 1014 may be controlled to be displayed clearly (or to be large or unshaded). According to an embodiment, the processor 320 may display only the day view mode button 1011, the month view mode button 1013, and the year view mode button 1014, instead of the current week view mode button 1022. The processor 320 according to an embodiment may receive a selection (or a touch input or another type of input) for one (e.g., the month view mode button 1013) of the day view mode button 1011, the month view mode button 1013, and the year view mode button 1014 in the display mode option 1020.

FIG. 10B is a diagram illustrating an example of displaying a calendar application (calendar) screen according to a month view mode in an electronic device according to an embodiment.

Referring to FIG. 10B, the processor 320 according to an embodiment may perform a display operation according to the month view mode shown in <1004>, based on the selection for the month view mode button 1013 from the display mode information 1020 in FIG. 10A. For example, the processor 320 may switch the display 360 to a further expanded state by a specified length than in the week view mode according to the month view mode, and display, on the display 360, a calendar application (calendar) screen of a month view in the further expanded state than in the week view mode. The processor 320 according to an embodiment may perform a display operation according to a year view mode shown in <1005>, based on the selection of the year view mode button 1014 in the display mode option 1020. For example, the processor 320 may switch the display 360 to a further expanded state by a specified length than in the week view mode according to the year view mode, and display, on the display 360, a calendar application (calendar) screen of a year view in the further expanded state than in the week view mode.

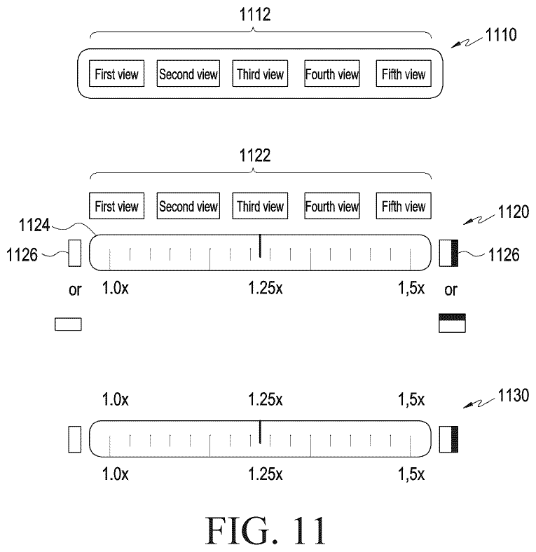

FIG. 11 is a diagram illustrating an example of displaying a display mode option according to an embodiment.

Referring to FIG. 11, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may display the display mode option as one of various types.

According to an embodiment, the first type of display mode option 1110 may include view mode buttons 1112 (e.g., a first view mode button, a second view mode button, a third view mode button, a fourth view mode button, and/or a fifth view mode button) (the number of mode buttons is not limited thereto). According to an embodiment, the respective view mode buttons 1112 may correspond to a plurality of view modes included in the respective applications.

According to an embodiment, the second type of display mode option 1120 may include view mode buttons 1122, a display screen size indicator (information or item) (e.g., a UI object that indicates the display screen size or enables selection therefor) 1124, and a display direction indicator (information or item) (e.g., a UI object that indicates the display direction or enables selection therefor) 1126. For example, the view mode buttons 1122 may correspond to view modes associated with display screen sizes. For example, the first view mode button may correspond to a view mode of a first display screen size, the second view mode button may correspond to a view mode of a second display screen size, the third view mode button may correspond to a view mode of a third display screen size, the fourth view mode button may correspond to a view mode of a fourth display screen size, and the fifth view mode button may correspond to a view mode of a fifth display screen size. For example, the display screen size may be associated with reducing or expanding the display 360. For example, the first display screen size may be the screen size when the display 360 is in a reduced state. The second display screen size may be the screen size when the display 360 is expanded by a first length from the reduced state. The third display screen size may be the screen size when the display 360 is expanded by a second length from the reduced state. The fourth display screen size may be the screen size when the display 360 is expanded by a third length from the reduced state. The fifth display screen size may be the screen size when the display 360 is expanded by a fourth length from the reduced state. For example, the first length, second length, third length, and fourth length may be different from each other. According to an embodiment, the display screen size indicator (or information) 1124 may indicate the display screen size determined by expanding or reducing the display. For example, the display screen size may be selected within the range of sizes from the reduced state (e.g., 1 time or 1.0×) to the expanded state (e.g., 1.5 times or 1.5× the reduced size). For example, 1.0× may indicate the display screen size when the display screen is in the reduced state. 1.25× may indicate the display screen size when the display 360 is expanded 1.25 times the display screen in the reduced state. 1.5× may indicate the display screen size when the display 360 is expanded 1.5 times the display screen in the reduced state. According to an embodiment, the display direction information 1126 may be information indicating whether content is displayed horizontally or vertically on the display screen of the electronic device 301.

According to an embodiment, the third type of display mode option 1130 may include only a view mode display screen size indicator 1134 and a display direction indicator 1136, excluding view mode buttons. According to an embodiment, the display mode options may be displayed in various other types related to the view modes of the electronic device 301 in addition to the above examples.

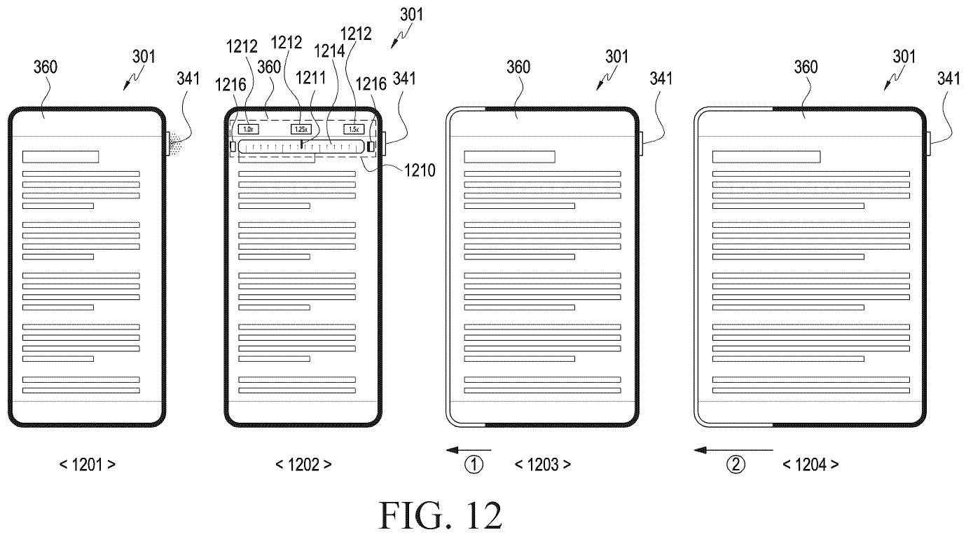

FIG. 12 is a diagram illustrating an example of displaying an application screen based on selection of a display size if a display mode option includes a display screen size indicator according to an embodiment.

Referring to FIG. 12, the processor 320 according to an embodiment may identify the occurrence of a display event for a display mode option while displaying an application screen on the display 360, as shown in <1201>. For example, the processor 320 may identify a display request for a display mode option, based on input (or touch or press) onto a specified key 341 while displaying the application screen.

The processor 320 according to an embodiment, based on the display request for the display mode option, may identify context information including that there is no view mode specified to running application or that the third type of display mode option (e.g., 1130) is configured to be displayed. The processor 320 according to an embodiment may display a display mode option 1210 corresponding to the identified context information, as shown in <1202>, on the display 360, based on the identified context information. For example, the processor 320 may display a display mode option 1210 including a display screen size indicator 1214 and a display direction indicator 1216, excluding view mode buttons. For example, the display screen size indicator 1214 may include sizes capable of being selected within the range of sizes from the reduced state (e.g., 1 time or 1.0×) to the expanded state (e.g., 1.5 times or 1.5× the reduced size). For example, 1.0× may indicate the display screen size when the display screen is in the reduced state. 1.25× may indicate the display screen size when the display 360 is expanded 1.25 times the display screen in the reduced state. 1.5× may indicate the display screen size when the display 360 is expanded 1.5 times the display screen in the reduced state. According to an embodiment, the display screen size indicator 1214 may include a display screen size recently (or most recently) used by the user or display screen sizes used frequently by the user.

According to an embodiment, the display direction indicator 1216 may be a UI object that indicates whether content is displayed horizontally or vertically on the display screen of the electronic device 301. The processor 320 according to an embodiment may receive a selection (or a touch input or another type of input) for a size from the display screen size indicator 1214 and perform a display operation in a corresponding mode, based on the selection for the size.

According to an embodiment, if 1.25× (1211) is selected from the display screen size indicator 1214, the processor 320 may adjust the display screen size to the size of 1.25× by partial expanding the same by a first length \textcircled{1} shown in <1203> and display the application screen in the display area having the size of 1.25×. According to an embodiment, if 1.5× (1212) is selected from the display screen size indicator 1214, the processor 320 may adjust the display screen size to the size of 1.5× by maximally expanding the same by a second length \textcircled{2} shown in <1204> and display the application screen in the display area having the size of 1.5×.

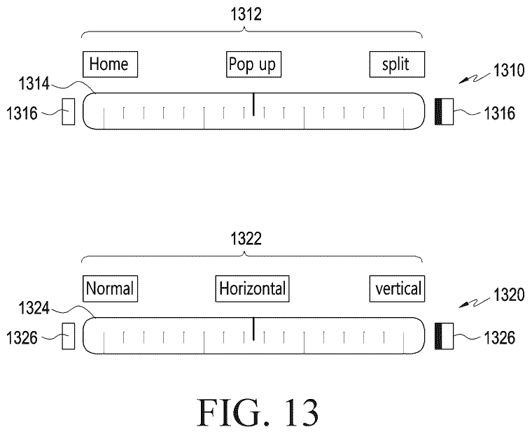

FIG. 13 is a diagram illustrating an example of displaying a display mode option associated with multiple application screens according to an embodiment.

Referring to FIG. 13, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may display a multi-display mode option, which is different from the display mode option in displaying a single application screen, when displaying multiple application screens. For example, the processor 320 may display a multi-display mode option as one of a plurality of types.

According to an embodiment, the first type of multi-display mode option 1310 may include view mode buttons 1312 corresponding to a home view (or overlay view), a pop-up view, and a split view associated with the multiple application screens, a display screen size indicator 1314, and a display direction indicator 1316. For example, the home view mode button may correspond to a view mode in which multiple applications are displayed to overlap each other on the home screen. The pop-up view mode button may correspond to a view mode in which one application screen is popped up and displayed on another application screen among the multiple applications. The split mode (horizontal split mode or vertical split mode) view button may correspond to a view mode in which multiple applications are displayed on display areas, respectively, that are horizontally or vertically split. The display screen size indicator 1314 may include a UI object indicating the display screen size determined by expanding or reducing the display. For example, the display screen size may be selected within the range of sizes from the reduced state (e.g., 1 time or 1.0×) to the expanded state (e.g., 1.5 times or 1.5× the reduced size). According to an embodiment, the display direction indicator 1316 may include a UI object that indicates whether content is displayed horizontally or vertically on the display screen of the electronic device 301.

According to an embodiment, the second type of multi-display mode option 1320 may include view mode buttons 1322 corresponding to a normal view mode (overlay view or pop-up view), a horizontal view mode, and a vertical view mode associated with the multiple application screens, a display screen size indicator 1324, and a display direction indicator 1326. For example, the normal view mode button may correspond to a view mode in which the multiple applications are displayed to overlap each other on the home screen or in which one application screen is displayed pop-up on another application screen among the multiple applications. The horizontal view mode button may correspond to a view mode in which the multiple applications are displayed in horizontally split display areas, respectively. The vertical view mode button may correspond to a view mode in which multiple applications are displayed in vertically split display areas, respectively. The display screen size indicator 1324 may include a UI object indicating the display screen size determined by expanding or reducing the display. For example, the display screen size may be selected within the range of sizes from the reduced state (e.g., 1 time or 1.0×) to the expanded state (e.g., 1.5 times or 1.5× the reduced size). According to an embodiment, the display direction indicator 1326 may include a UI object that indicates whether content is displayed horizontally or vertically on the display screen of the electronic device 301.

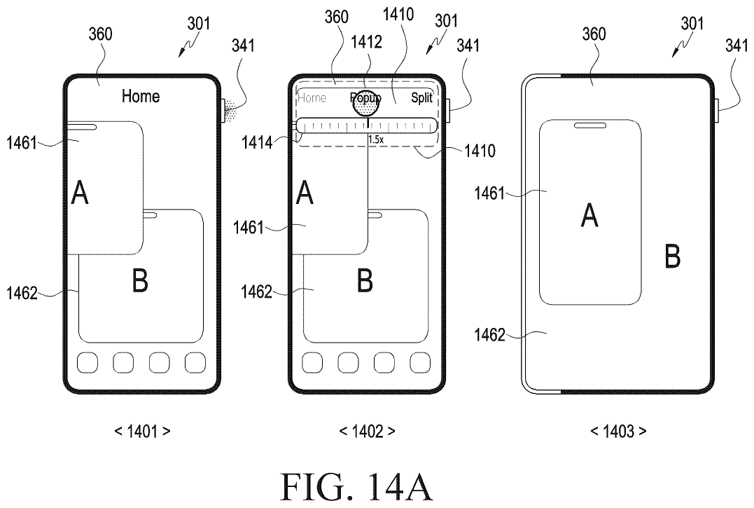

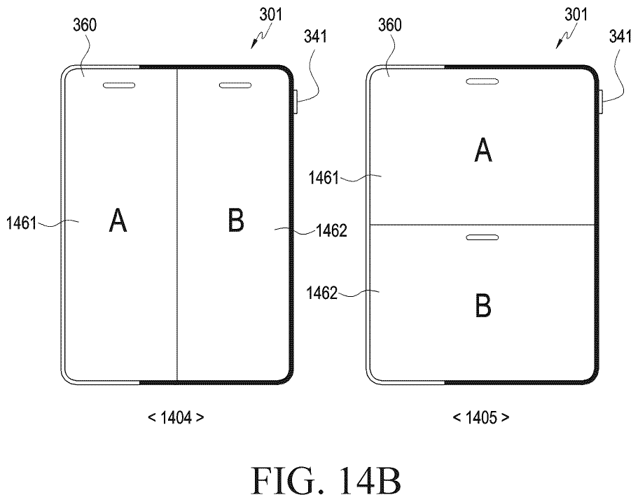

FIG. 14A is a diagram illustrating an example of displaying a display mode option including a home view mode button, a pop-up view mode button, and a split view mode button when displaying multiple application screens in an electronic device according to an embodiment.

Referring to FIG. 14A, a processor (e.g., the processor 120 in FIG. 1 or the processor 320 in FIG. 3) of an electronic device (e.g., the electronic device 101 in FIG. 1 or the electronic device 301 in FIG. 3) according to an embodiment, based on execution of multiple applications (e.g., execution of application A and execute of application B), may display a screen 1461 of application A and a screen 1462 of application B to overlap each other on the display 360 (or the home screen of the display 360) as shown in <1401>. The processor 320 according to an embodiment may identify the occurrence of a display event for a display mode option while displaying the screen 1461 of application A and the screen 1462 of application B. For example, the processor 320 may identify a display request for a display mode option, based on input (or touch or press) onto a specified key 341 while displaying the screen 1461 of application A and the screen 1462 of application B. The processor 320 according to an embodiment may identify context information, based on the display request for a display mode option. For example, the processor 320 may identify context information indicating that multiple application screens are being displayed.

The processor 320 according to an embodiment, based on the identified context information, may display a multi-display mode option 1410 corresponding to the identified context information on the display 360, as shown in <1402>. For example, the processor 320 may display a display mode option 1410 that includes view mode buttons 1412 including a home view mode button, a pop-up view mode button, and a split view mode button, and a display screen size indicator 1414. For example, the processor 320 may perform control such that the home view mode button corresponding to the current home view mode is displayed dimly (or to be small or shaded) and such that the pop-up view mode button and the split view mode button are displayed clearly (or to be large or unshaded). According to an embodiment, the processor 320 may not display the current home view mode button, but may display the pop-up view mode button and the split view mode button.

The processor 320 according to an embodiment may perform a display operation according to the pop-up view mode, based on a selection (or touch input or another type of input) for the pop-up view mode button of the pop-up view mode button and the split view mode button in the multi-display mode option 1410, as shown in <1403>. For example, the processor 320 may switch the display 360 to a partially expanded state according to the pop-up view mode and perform control such that one (e.g., the screen 1462 of application B) of the multiple application screens is popped up and displayed on another application screen (e.g., the screen 1461 of application A) in the partially expanded state.

The processor 320 according to an embodiment, based on a selection (or touch input or another type of input) for the split view mode button from among the pop-up view mode button and the split view mode button in the multi-display mode option 1410, may split the display area horizontally or vertically and perform control such that the multiple applications are displayed in the horizontally or vertically split areas, respectively.

FIG. 14B is a diagram illustrating an example of a split view mode according to an embodiment.

Referring to FIG. 14B, the processor 320 according to an embodiment, based on a selection for the split mode view button, may perform a display operation based on the horizontal split view mode shown in <1404> or perform a display operation based on the vertical split view mode shown in <1405>. For example, the processor 320, based on a selection (or touch input or another type of input) for the split view mode button from the multi-display mode information 1410, may split the display area horizontally, as shown in <1404>, and display the screen 1461 of application A and the screen 1462 of application B in the horizontally split display areas, respectively. For example, the processor 320, based on a selection (or touch input or another type of input) for the split view mode button from the multi-display mode information 1410, may split the display area vertically, as shown in <1405>, and display the screen 1461 of application A and the screen 1462 of application B in the vertically split display areas, respectively.

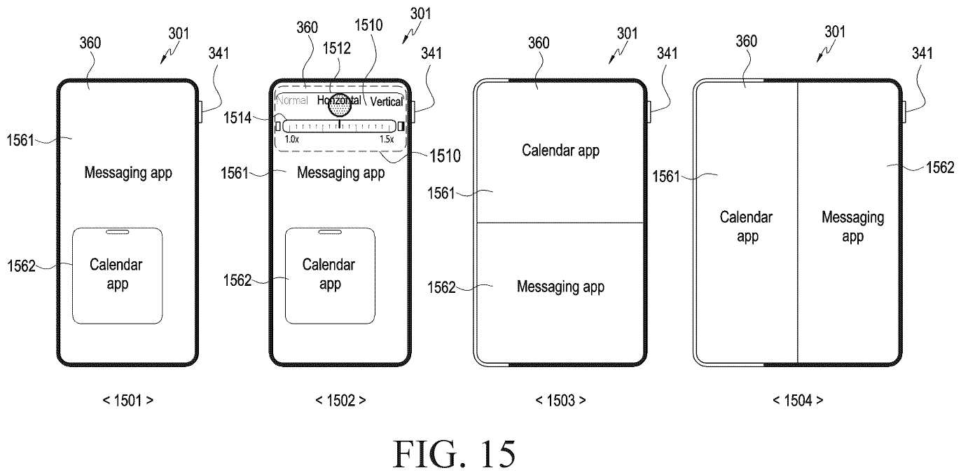

FIG. 15 is a diagram illustrating an example of displaying a display mode option including a normal view mode, a horizontal view mode, and a vertical view mode when displaying multiple application screens in an electronic device according to an embodiment.

Referring to FIG. 15, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying a calendar application screen 1561 and a messaging application screen 1562 on the display 360, as shown in <1501>. For example, the processor 320 may identify a display request for a display mode option, based on input (or touch or press) onto a specified key 341 while displaying the calendar application screen 1561 and the messaging application screen 1562. The processor 320 according to an embodiment may identify context information, based on the display request for a display mode option. For example, the processor 320 may identify context information indicating that multiple application screens (the calendar application screen 1561 and the messaging application screen 1562) are being displayed.

The processor 320 according to an embodiment, based on the identified context information, may display a multi-display mode option 1510 corresponding to the identified context information on the display 360, as shown in <1502>. For example, the processor 320 may display a display mode indicator 1510 that includes view mode buttons 1512 including a normal view mode button, a horizontal view mode button, and a vertical view mode button, and a display screen size indicator 1514. For example, the processor 320 may perform control such that the normal view mode button corresponding to the current normal view mode is displayed dimly (or to be small or shaded) and such that the horizontal view mode button and the vertical view mode button are displayed clearly (or to be large or unshaded). According to an embodiment, the processor 320 may not display the current normal view mode button, but may display the horizontal view mode button and the vertical view mode button.

The processor 320 according to an embodiment, based on a selection (or touch input or another type of input) for the horizontal view mode button from among the horizontal view mode button and the vertical view mode button in the multi-display mode information 1510, may perform a display operation according to the horizontal view mode as shown in <1503>. For example, the processor 320 may switch the display 360 to a partially expanded state according to the horizontal view mode, split the display area horizontally in the partially expanded state, and display the calendar application screen 1561 and the messaging application screen 1562 in the horizontally split areas, respectively.

The processor 320 according to an embodiment, based on a selection (or touch input or another type of input) for the vertical view mode button from among the horizontal view mode button and the vertical view mode button in the multi-display mode option 1510, may perform a display operation according to the vertical view mode as shown in <1504>. For example, the processor 320 may switch the display 360 to an expanded state according to the vertical view mode, split the display area vertically in the expanded state, and display the calendar application screen 1561 and the messaging application screen 1562 in the vertically split areas, respectively.

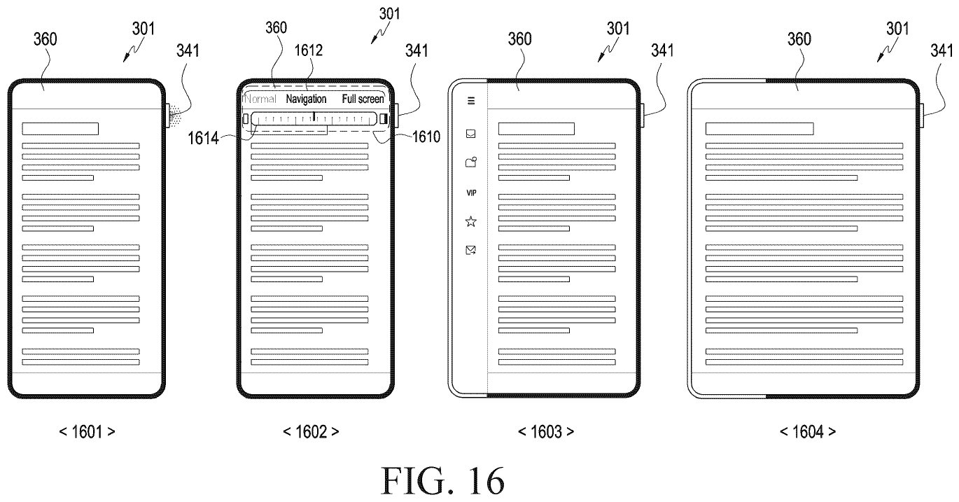

FIG. 16 is a diagram illustrating an example of displaying a display mode option if an application does not include a specified view mode in an electronic device according to an embodiment.

A processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying an application screen on the display 360, as shown in <1601>. For example, the processor 320 may identify a display request for a display mode option, based on input (or touch or press) onto a specified key 341 while displaying the application screen. The processor 320 according to an embodiment may identify context information, based on the display request for a display mode option. For example, the processor 320 may identify information indicating that the application does not include a specified view mode, information about a view mode recently (or most recently) used by the user in association with the application or a view mode frequently used by the user in association with the application, and/or context information indicating that the current view mode is the normal view mode.

The processor 320 according to an embodiment, based on the identified context information, may display a display mode option 1610 corresponding to the identified context information, as shown in <1602>, on the display 360. For example, the processor 320 may display a display mode option 1610 that includes view mode buttons 1612 including a normal view mode button, a navigation view mode button, and a full screen view mode button, and a display screen size indicator 1614.

For example, the processor 320 may perform control such that the normal view mode button corresponding to the current normal view mode is displayed dimly (or to be small or shaded) and such that the navigation view mode button and the full screen view mode button are displayed clearly (or to be large or unshaded). According to an embodiment, the processor 320 may not display the current normal view mode button, but may display the navigation view mode button and the full screen view mode button.

For example, the processor 320 may perform control such that the button, among the normal view mode button, the navigation view mode button, and the full screen view mode button, corresponding to the view mode recently (or most recently) used by the user or the view mode most frequently used by the user in relation to the application is displayed in the center of the display area of the display mode option 1610.

The processor 320 according to an embodiment, based on a selection (or touch input or another type of input) for the navigation view mode button from among the navigation view mode button and the full screen view mode button in the display mode option 1610, may perform a display operation according to the navigation view mode as shown in <1603>. For example, the processor 320 may switch the display 360 to a partially expanded state according to the navigation view mode and display a navigation menu in the partially expanded area of the display area in the partially expanded state.

The processor 320 according to an embodiment, based on a selection (or touch input or another type of input) of the full screen view mode button from among the horizontal view mode button, the vertical view mode button, the navigation view mode button, and the full screen view mode button in the display mode option 1610, may perform a display operation according to the full screen view mode, as shown in <1604>. For example, the processor 320 may switch the display 360 to an expanded state according to the full screen view mode and display an application screen in the display area in the expanded state.

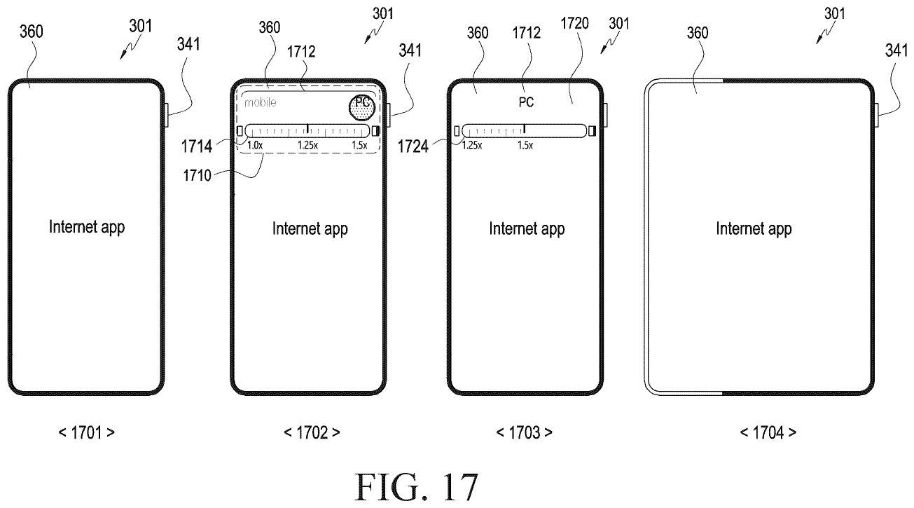

FIG. 17 is a diagram illustrating an example of displaying a display mode option based on usage history for an application in an electronic device according to an embodiment.

Referring to FIG. 17, a processor (e.g., the processor 120 in FIG. 1 or the processor 320 in FIG. 3) of an electronic device (e.g., the electronic device 101 in FIG. 1 or the electronic device 301 in FIG. 3) according to an embodiment may identify the occurrence of a display event for a display mode option while displaying an application screen (e.g., an Internet application screen) on the display 360, as shown in <1701>. For example, the processor 320 may identify a display request for a display mode option, based on input (or touch or press) onto a specified key 341 while displaying the Internet application screen. The processor 320 according to an embodiment may identify context information, based on the display request for a display mode option. For example, processor 320 may include a location (current location), a time (current time), and/or a view mode (current view mode) associated with the electronic device 301 (or the user of the electronic device 301). The processor 320 according to an embodiment, based on information about the user usage history of Internet application screen, may identify whether to provide a display mode option using context information, regardless of (without using) the usage history information, or provide a display mode option using the usage history information.

In the case of providing a display mode option using context information regardless of the usage history information, the processor 320 according to an embodiment, based on the identified context information, may display a display mode option 1710 corresponding to the identified context information, as shown in <1702>, on the display 360. For example, the processor 320 may display a display mode option 1710 that includes view mode buttons 1712 including a mobile view mode button and a PC view mode button, and a display screen size indicator 1714. For example, if the current view mode is a mobile view, the processor 320 can perform control such that the mobile view mode button corresponding to the current mobile view mode is displayed dimly (or to be small or shaded) and such that the PC view mode button is displayed clearly (or to be large or unshaded). According to an embodiment, the processor 320 may not display the current mobile view mode button, but may display the PC view mode button.

In the case of providing a display mode option using usage history information, the processor 320 according to an embodiment, based on the usage history information, may display a display mode option 1720 corresponding to the usage history information, as shown in <1703>, on the display 360. For example, the usage history information may include information about a view mode used recently (or most recently) by the user or a view mode used most frequently by the user in relation to an application. For example, if the view modes corresponding to the Internet application include a mobile view mode and a PC view mode, and if the view mode used recently (or most recently) by the user or the view mode used most frequently by the user in relation to an application is a PC mode, based on the usage history information, the processor 320 may display a display mode option 1720 including a PC view mode button and perform control such that the PC view mode button is disposed in the center of the display area of the display mode option 1720.

According to an embodiment, when providing a display mode option 1720 using the usage history information, the processor 320 may perform control such that a display operation corresponding to the PC view mode is automatically performed as shown in <1704> even without further selection for the PC view mode button.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, a non-volatile storage medium may store instructions configured to cause, when executed by at least one processor, the at least one processor to perform at least one operation, wherein the at least one operation may include, based on execution of an application, identifying a display event for a display mode option while displaying a screen of the application on a flexible display, identifying first context information based on context information associated with the electronic device, according to the display event for the display mode option, displaying a first display mode option including at least some or all of the view modes associated with the application or the electronic device, based on the first context information, identifying second context information, based on a change in the context information associated with the electronic device, and displaying a second display mode option different from the first display mode option, based on the second context information.

The embodiments of the disclosure described and shown in the specification and the drawings are merely specific examples that have been presented to easily explain the technical contents according to embodiments of the disclosure and help understanding of embodiments of the disclosure, and are not intended to limit the scope of embodiments of the disclosure. Therefore, the scope of various embodiments the disclosure should be construed to include, in addition to the embodiments set forth herein, all changes and modifications derived based on the technical idea of various embodiments of the disclosure.

What is claimed is:

1. An electronic device comprising:
a flexible display connected to a housing;
a slide driving unit configured to slide the flexible display in an extension direction or reduction direction;
memory for storing instructions; and
at least one processor operably connected to the flexible display and the slide driving unit,
wherein the instructions, when executed by the at least one processor, cause the electronic device to:
identify, based on execution of an application, a display event for a display mode option while displaying a screen of the application on the flexible display,
identify first context information, based on context information associated with the electronic device, according to the display event for the display mode option,
display a first display mode option comprising at least one or more of view modes associated with the application or the electronic device, based on the first context information,
identify second context information, based on a change in the context information associated with the electronic device, and
display a second display mode option different from the first display mode option, based on the second context information.

2. The electronic device according to claim 1, wherein the display event comprises a specified key input event or an event generated by the application while displaying the screen of the application.

3. The electronic device according to claim 1, wherein the context information associated with the electronic device comprises at least one of a location, a time, and a view mode associated with the electronic device.

4. The electronic device according to claim 1, wherein each of the first display mode option and the second display mode option comprises at least one view mode button.

5. The electronic device according to claim 4, wherein each of the first display mode option and the second display mode option further comprises at least one of a display screen size indicator or a display direction indicator.

6. The electronic device according to claim 4, wherein the instructions, when executed by the at least one processor, cause the electronic device to:
perform a display operation corresponding to a view mode button selected from among the at least one view mode button, or
adjust a display screen size by controlling the flexible display to slide in the extension direction or the reduction direction in response to the view mode button selected.

7. The electronic device according to claim 4, wherein the at least one view mode button comprises a plurality of view mode buttons,
wherein the instructions, when executed by the at least one processor, cause the electronic device to:
display a first view mode button corresponding to a current view mode, among the plurality of view mode buttons, in a first display scheme, and
display a second view mode button not corresponding to the current view mode in a second display scheme.

8. The electronic device according to claim 1, wherein the instructions, when executed by the at least one processor, cause the electronic device to:
identify whether to display multiple application screens on the flexible display, and
display a multi-display mode option when displaying the multiple application screens, and
wherein the multi-display mode option comprises at least one of an overlay view mode button, a pop-up view mode button, a horizontal view mode button, or a vertical view mode button.

9. The electronic device according to claim 1, wherein the instructions, when executed by the at least one processor, cause the electronic device to:
identify whether to provide the display mode option using usage history information of the application, based on the display event for the display mode option, and
when it is identified that the display mode option is to be provided using the usage history information, provide the display mode option including a view mode button most recently used for the application.

10. A method of displaying display mode information, based on context information in an electronic device, the method comprising:
based on execution of an application, identifying a display event for a display mode option while displaying a screen of the application on a flexible display;
identifying first context information based on the context information associated with the electronic device, according to the display event for the display mode option;
displaying a first display mode option comprising at least one or more of view modes associated with the application or the electronic device, based on the first context information;
identifying second context information, based on a change in the context information associated with the electronic device; and
displaying a second display mode option different from the first display mode option, based on the second context information.

11. The method according to claim 10, wherein the display event comprises a specified key input event or an event generated by the application while displaying the screen of the application.

12. The method according to claim 10, wherein each of the first display mode option and the second display mode option comprises at least one view mode button,
wherein the method further comprises displaying a view mode corresponding to a view mode button selected from among the at least one view mode button,
wherein the displaying of the view mode corresponding to the view mode button selected comprises adjusting a display screen size by controlling the flexible display of the electronic device to slide in an extension direction or an reduction direction in response to the view mode corresponding to the view mode button selected.

13. The method according to claim 12, wherein the at least one view mode button comprises a plurality of view mode buttons,
wherein the method further comprises displaying a first view mode button corresponding to a current view mode, among the plurality of view mode buttons, in a first display scheme and displaying a second view mode button not corresponding to the current view mode in a second display scheme,
wherein the first view mode button is a view mode button corresponding to a first display screen size, and
wherein the second view mode button is a view mode button corresponding to a second display screen size.

14. The method according to claim 10, further comprising:
identifying whether to display multiple application screens on the flexible display; and
displaying a multi-display mode option when displaying the multiple application screens,
wherein the multi-display mode option comprises at least one of an overlay view mode button, a pop-up view mode button, a horizontal view mode button, or a vertical view mode button.

15. A non-volatile storage medium storing instructions configured to cause, when executed by at least one processor of an electronic device, the at least one processor to perform operations comprising:
based on execution of an application, identifying a display event for a display mode option while displaying a screen of the application on a flexible display;
identifying first context information based on context information associated with the electronic device, according to the display event for the display mode option;
displaying a first display mode option comprising at least one or more of view modes associated with the application or the electronic device, based on the first context information;
identifying second context information, based on a change in the context information associated with the electronic device; and
displaying a second display mode option different from the first display mode option, based on the second context information.

16. The electronic device according to claim 7, wherein the first view mode button is a view mode button corresponding to a first display screen size, and
wherein the second view mode button is a view mode button corresponding to a second display screen size.

17. The method according to claim 10, wherein the context information associated with the electronic device comprises at least one of a location, a time, and a view mode associated with the electronic device.

18. The method according to claim 10, wherein each of the first display mode option and the second display mode option further comprises at least one of a display screen size indicator or a display direction indicator.

19. The method according to claim 10, further comprising:
identifying whether to display multiple application screens on the flexible display, and
displaying a multi-display mode option when displaying the multiple application screens,
wherein the multi-display mode option comprises at least one of an overlay view mode button, a pop-up view mode button, a horizontal view mode button, or a vertical view mode button.

20. The method according to claim 10, further comprising:
identifying whether to provide the display mode option using usage history information of the application, based on the display event for the display mode option, and
when it is identified that the display mode option is to be provided using the usage history information, providing the display mode option including a view mode
button most recently used for the application.
